(19) United States
(12) Patent Application Publication
(10) Pub. No.: US 2004/0104147 A1
(43) Pub. Date: Jun. 3, 2004

(54) Heavy oil upgrade method and apparatus

(76) Inventor: Michael Y. Wen, Katy, TX (US)

Correspondence Address: ExxonMobil Upstream Research Company, P. O. Box 2189, Houston, TX, 77252-2189, US

(21) Appl. No.: 10/657,360

(22) Filed: Sep. 8, 2003

Related U.S. Application Data
(63) Continuation-in-part of application No. 10/125,669, filed on Apr. 18, 2002.
(60) Provisional application No. 60/285,212, filed on Apr. 20, 2001.

(51) Int. Cl. C10G 47/00; B01J 10/00

(52) U.S. Cl. 208/107; 208/106; 208/14; 422/189; 422/194

(57) ABSTRACT

A method and reactor for upgrading a hydrocarbon in which an oxygen source and a hydrocarbon source are ignited and the resulting synthetic gas is used to initiate a gas phase heavy oil upgrade reaction. The upgrade reaction is quenched quickly after initiation of the gas phase reaction.

### CROSS-REFERENCE TO RELATED APPLICATIONS

This application is a continuation-in-part application and claims priority to U.S. application Ser. No. 10/125,669, filed Apr. 18, 2002 which claims benefit from U.S. Provisional Application No. 60/285,212, filed on Apr. 20, 2001.

### FIELD OF THE INVENTION

This invention relates to the upgrading of heavy oil into lighter oil.

### BACKGROUND OF THE INVENTION

A substantial portion of the world's oil reserves comprise bitumens, which are sometimes referred to as tar sands, and heavy crude oils (collectively “heavy oil”). Heavy oil is difficult to produce, and, when produced, is difficult to market. Whether pipelines or shipping facilities are used as the transportation medium, the cost of transporting heavy oil is substantially higher than the cost for the transporting of light oil. Once heavy oil is delivered at a receiving refinery, more costly refinery processes are required to generate products suitable for the commercial marketplace. As a result, the economic value of heavy oil is lower than the value of light oil, and for that reason a significant percentage of the world's heavy oil reserves remain underutilized.

To alleviate this underutilization problem, numerous methods have been proposed to upgrade heavy oil. Although the terms “heavy oil” and “upgrade” can be defined using several different technical parameters, one parameter that is frequently used to characterize the quality of hydrocarbons is API gravity. Heavy oil is characterized by a generally low API gravity, for example but without limitation in the range of API 5 to API 25. Light oils have higher magnitude API gravities, for example in the range API 35 to API 50. The term “upgrade” refers to the process of increasing the API gravity of oil from a relatively lower API gravity to a relatively higher API gravity. For example, but without limitation, oil can be upgraded from API 5 to API 15, or from API 30 to API 40. Upgrade is a relative term, and is not limited to a specific initial API gravity value, or range, nor to a specific final API gravity value, or range. Finally, the phrase “heavy oil upgrade reaction” refers generically to the chemical activities that occur in the process of upgrading heavy oil.

Heavy oil upgrade methods sometimes involve pre-processing steps intended to increase the efficiency of the heavy oil upgrade reaction. For example, U.S. Pat. No. 4,294,686 discloses the preliminary distillation of the heavy oil stream into a light oil fraction and heavy oil fraction. The purpose of the preliminary distillation is to avoid the unwanted cracking and coking of the light oil fraction that might occur if that fraction were included in the input stream to the upgrade reactor. The light oil fraction that results is generally in a form satisfactory either for use in the production facility as a fuel or for transport to a refinery. However, preliminary distillation adds both cost and complexity to the overall upgrade process, and is useful only where the heavy oil is known to include a sufficient volume of light hydrocarbons.

Other proposed upgrade methods include the pre-processing step of mixing of an oil additive with the heavy oil. The resulting mixture is then input to an upgrade reactor. For example, U.S. Pat. No. 6,059,957 discloses the creation of an emulsion from the mixing of heavy oil and water. That disclosure also provides for the optional inclusion of an emulsion-stabilizing surfactant. U.S. Pat. No. 6,004,453 discloses the creation of a slurry from the mixing of a noncatalytic additive with the heavy oil. The publication of Moll, J. K. and Ng, F. T. T., “A Novel Process for Upgrading Heavy Oil/Bitumen Emulsions Via In Situ Hydrogen,” 16th World Petroleum Congress, Calgary, Canada, June 2000, discloses use of an emulsion from a water-soluble dispersed catalyst. Each of these three methods has two general limitations however. First, the mixing step adds both cost and complexity to the overall upgrading process. Second, the additives cause the creation of waste materials during the upgrade reactions that must thereafter be appropriately processed and disposed. That processing and disposal also adds cost and complexity.

A third set of heavy oil upgrade methods include the step of using a reaction additive in the upgrade reactor to facilitate, or improve the efficiency of, the upgrade reaction. For example, the publication of Paez, R., Luzardo, L., and Guitian, J., “Current and Future Upgrading Options for the Orinoco Heavy Crude Oils,” 16th World Petroleum Congress, Calgary, Canada, June 2000, discloses the use of coke or iron-based catalysts in the upgrading process. Disclosure WO 00/61705 discloses the use of a non-catalytic particulate heat carrier. U.S. Pat. No. 5,817,229 discloses the use of activated carbon, in the absence of added hydrogen, to both reduce the content of undesirable minerals and to upgrade the quality of the input crude. These methods have both of the limitations of the oil additive methods discussed above, namely added cost and complexity and increased waste material processing requirements.

The hydrogenation method of U.S. Pat. No. 5,069,775 reacts hydrogen and heavy oil for from five minutes to four hours in a preferred reaction temperature range of 800 to 900° F. (427 to 482° C.). U.S. Pat. No. 5,269,909 discloses a method whereby a gas rich in methane is reacted with heavy oil for at least thirty minutes in a preferred temperature range of 380 to 420° C. (716 to 788° F.). The method of U.S. Pat. No. 5,133,941 flows hydrogen and heavy oil through sequentially connected reaction passageways in a preferred temperature range of 700 to 900° F. (371 to 482° C.). As will be understood to those skilled in the art, a limitation of these methods is that the generally long reaction durations cause a substantial increase in the generation of undesirable waste materials, specifically pitch, coke, and olefins. These materials create significant disposal challenges for the processing facility, and, in addition, lead to a reduction in the efficiency of the facility.

Disclosure WO 00/18854 discloses a two-part process in which hydrogen gas is mixed with heavy oil in a manner that attempts to achieve molecular level dispersion of hydrogen throughout the heavy oil. The method has a first upgrade reaction that separates the lighter hydrocarbons from the heavy oil, and continues with a second upgrade reaction in a second reactor. The second upgrade reaction further upgrades the heavy oil via a hydrogenation reaction within a preferred temperature range of 343 to 510° C. (650 to 950° F.). The method includes the added step of providing externally supplied heat to the hydrogen-heavy oil mixture to further facilitate the reaction in the second reactor. Limitations of this process include the difficulty of achieving the required uniform mixing of hydrogen and heavy oil, and the cost and complexity of implementing a process that requires two reaction steps.

These and other previously proposed upgrade methods suffer from an inherent limitation that has long plagued industry. On one hand, it is well known to those skilled in the art that upgrade reactions are preferably carried out at the highest possible reaction temperature, since upgrade processes are more efficient at higher temperatures. Unfortunately, as is also well known to those skilled in the art, high reaction temperatures can lead to significant unwanted cracking and coking of the heavy oil molecules if the reactions are not quickly quenched. None of these methods have a mechanism for quickly quenching the reactions and they are therefore constrained to lower temperature operating ranges. On the other hand, however, reaction durations are longer at lower temperatures, and it is equally well known that long reaction also lead unwanted cracking and coking, and, in addition, to lower process efficiencies due to the extra time required for the upgrade. These methods are therefore constrained to a compromise temperature range that is a tradeoff between these limitations.

WO 00/23540 discloses a method in which a jet of gas, comprising essentially of superheated steam, activates the upgrading of the heavy oil. The method has a number of limitations. Using steam as the hydrogenation mechanism means that both hydrogen and oxygen-hydrogen radicals are generated in the upgrade reactions. As a result, fewer hydrogen molecules are available, in comparison to processes in which hydrocarbon-based gases are predominantly used, to saturate the carbon radicals created from the heavy oil carbon bond breaking. In addition, a large volume of superheated steam is required. Because steam generation is endothermic, this constraint is costly, self-limiting, and inherently inefficient—fuel is consumed to generate steam, but the energy in that steam is only passively used to provide a thermal input to the upgrading of the heavy oil. Thus energy losses are incurred both in the generation of the steam and in the passive upgrade. This limits the efficiency of the upgrading process.

Another limitation of WO 00/23540 is that the bonding of oxygen-hydrogen radicals from the steam with carbon radicals from the heavy oil creates an output product in an emulsion form. Emulsions are a less desirable product at refineries due to the need to handle the increased volume of produced water that results during the refining process. Emulsions also add the requirement for a post-reaction soaking drum to ensure stabilization of the output products. Because soakers cannot quickly quench upgrade reactions or actively control stabilization times, this limitation leads to the creation of pitch and other unwanted waste materials.

Finally, WO 00/23540 is also constrained by the use of steam as the predominant hydrogenation source for the upgrade reaction. Steam causes side reactions that cannot be completely inhibited except under a narrow range of pressure and temperature conditions. Outside that range, unwanted gases and waste products are generated, and the output product suffers a loss of stability. As a result, reaction temperatures are generally limited to 500° C. (932° F.) or less, another efficiency constraint. For additional background, see U.S. Pat. No. 4,298,457 to Oblad et al. and U.S. Pat. No. 4,415,431 to Matyas et al.

It is apparent that a need exists for a method that can be carried out without the use of reaction additives. The method should avoid unwanted cracking and coking of the heavy oil, and minimize the production of undesirable waste materials. The upgrade efficiency of the method should not require uniform dispersion of hydrogen or other input gas throughout the heavy oil, or require relatively long high temperature exposure durations of the input gas to the heavy oil.

Furthermore, a need exists for a method that can preferably be carried out at high temperatures, to thereby facilitate short reaction times and high upgrade efficiencies. The method should involve a direct mechanism of transferring the heat input to the heavy oil to be upgraded. The method should include an active mechanism for quickly quenching the upgrade reactions. Differing embodiments of the present invention satisfy some of these needs.

### SUMMARY

One embodiment of the invention includes a heavy oil upgrading reactor. The heavy oil upgrading reactor may include a partial oxidation reaction chamber that is suitable for generating syngas, where the syngas contains hydrogen gas. The heavy oil upgrading reactor may include a heavy oil upgrading reaction chamber. The heavy oil upgrading reaction chamber may include a high temperature reaction zone suitable for thermally cracking at least a portion of the heavy oil in the presence of the syngas at a temperature in excess of 1225° F. for less than 10 seconds to form a thermally cracked oil. The heavy oil upgrading reaction chamber may include a rapid quench zone suitable for quenching the thermally cracked oil with a heavy oil quench within 10 seconds of the initiation of the thermal cracking of the heavy oil in the high temperature reaction zone. The heavy oil upgrading reaction chamber may include a stabilization zone suitable for providing a residence time for the thermally cracked oil of from 1 to 60 minutes at a reduced temperature below 850° F. to form an upgraded oil mixture. The heavy oil upgrading reaction chamber may include one or more eduction nozzle(s) suitable for receiving the syngas formed in the partial oxidation reaction chamber. The syngas may flow through the eduction nozzle at a velocity sufficient to educe heavy oil from the heavy oil reaction chamber into the eduction nozzle thereby contacting the syngas with at least a portion of the heavy oil. The heavy oil upgrading reactor may include a passage suitable for withdrawing at least a portion of the upgraded oil mixture from the heavy oil upgrading reaction chamber.

One embodiment of the invention includes a heavy oil upgrading process that produces 80 wt. % or greater of liquid products. The process may include thermally cracking a feed oil comprising heavy oil at a temperature above 1225° F. for less than 10 seconds in the presence of a hydrogen-containing gas to produce a thermally cracked oil product. The process may include quenching the thermally cracked oil product within 10 seconds of the initiation of the thermal cracking of the feed oil by mixing the thermally cracked oil product with a quench oil to form a quenched oil product. The process may include stabilizing the quenched oil product at a temperature below 850° F. for from 1 to 60 minutes to form a stabilized oil product.

### BRIEF DESCRIPTION OF THE DRAWINGS

The features of the present invention will become more apparent from the following description in which reference is made to the drawings appended hereto. Reference numbers that are used in more than one of the drawings refer to the same function in each drawing.

FIG. 1 is a sectional-view of an embodiment of an injection reactor that may be used in some embodiments of the method of the present invention.

FIG. 2 is a schematic representation generally illustrating one embodiment of a heavy oil upgrade method of the present invention.

FIG. 3 is a more detailed schematic representation of the heavy oil upgrade method illustrated in FIG. 1, with an expanded illustration of heat exchanger and separation equipment.

FIG. 4 is similar to FIG. 3, except that recycled unreacted heavy oil is added to the input to the injection reactor of the method of the present invention.

FIG. 5 is a schematic representation illustrating an embodiment of a partial oxidation reactor that may be used in the method of the present invention, with an expanded illustration of heat exchanger and separation equipment.

FIG. 6 is similar to FIG. 5, with the addition of recycled tail gas as an input to the partial oxidation reactor.

FIG. 7 is a view of one embodiment of an integrated two reaction chamber reactor containing a partial oxidation reaction chamber and a heavy oil upgrading reaction chamber.

FIG. 8 is a view from inside the heavy oil upgrading reaction chamber depicted in FIG. 7 looking down at the bottom of the heavy oil upgrading reaction chamber.

FIG. 9 depicts an integrated two reaction chamber pilot plant reactor according to one embodiment of the invention.

FIG. 10 depicts a simplified integrated two reaction chamber pilot plant reactor process flow diagram according to one embodiment of the invention.

FIG. 11 is a sectional-view of an embodiment of an injection that may be used in some embodiments of the method of the present invention.

Changes and modifications in the specifically described embodiments can be carried out without departing from the scope of the invention, which is intended to be limited only by the scope of the appended claims.

### DETAILED DESCRIPTION OF THE INVENTION

The present invention is directed to the upgrading of heavy oil, and is often referred to as the “Partial Crude Upgrading” (“PCU”) process. Embodiments of the PCU process can alternatively upgrade oil in one step, without the need for a preliminary distillation or for oil or reaction additives. These advantages increase the simplicity and lower the cost of the PCU process in comparison to previously proposed heavy oil upgrade techniques.

Embodiments of the PCU process rapidly heat heavy oil, thereby quickly breaking carbon bonds in the heavy oil molecules. This characteristic shortens the time required for the overall upgrade process and increases the efficiency of the entire upgrade facility. The reactions may be quickly quenched by unreacted, in other words un-upgraded, heavy oil. This active quenching technique reduces both the amount of coking that typically occurs when upgrade reactions are not quickly controlled and the production of other unwanted waste materials.

In one embodiment, the upgrade reaction for the PCU process is initiated by the injection of compressed air and a fuel mixture into a reactor vessel. Extremely high reaction temperatures result from the ignition of those gases by igniters in the injectors. These temperatures result from an exothermic reaction that releases a high amount of energy for the vaporization of, and cracking of the molecular bonds in, the heavy oil molecules. The heavy oil upgrade results from the exposure of the heavy oil molecules to the energy released by the exothermic reaction. The exothermic generation of energy is an aspect of the present invention in comparison to previous methods, because an increased amount of energy thereby becomes available for the breaking of the molecular bonds in the heavy oil.

The energy in the PCU process results from the partial oxidation reaction of compressed air with the fuel mixture. The compressed air acts as the oxidizing agent and the fuel mixture as the hydrogen source in the reaction which creates a synthetic gas, referred to as syngas. The creation of syngas allows high temperatures to be exothermically created for the upgrade reaction, and shortens upgrade reaction times compared to previously proposed upgrade techniques. Syngas also contains reactive gas components that facilitate the upgrade reaction, and preferably generates an oversupply of hydrogen radicals for bonding with carbon radicals created by the upgrade reactions. Having carbon radicals bond with hydrogen rather than with other undesirable radicals, a result which typically occurs from the use of gases which are predominantly composed of superheated steam, reduces the likelihood that the output product will be an undesirable emulsion or that coke, pitch and unstable olefins will be created.

Gaseous hydrocarbons, such as natural gas, are the preferred fuels to generate syngas, because of their high concentration of hydrogen. However, either liquid fuels or heavy oil feeds may be used in syngas generation. Furthermore, either air, enriched air (e.g. air enriched with additional oxygen), or pure oxygen may be used as the oxygen source. The reactor vessel within which the heavy oil cracking and quenching takes place may operate at pressures below 700 psig (4,928 kPa), and more preferably may be operated at pressures below 500 psig (2,859 kPa).

The reactions may be quenched in the same reactor vessel using unreacted heavy oil, which is at a lower temperature than is the upgraded heavy oil. Quenching occurs shortly after exposure of the heavy oil to the syngas. Control of the reactor pressures, and the rate of input of air, fuel, and unreacted heavy oil, provides for a method of controlling the rate at which the reactions are quenched.

The PCU process facilitates synergies between fuel and heat integration and the production facilities. Fuel gas produced by the PCU process may be used to generate high-pressure steam, which may be used, for example, to assist heavy oil production or to preheat the feeds to the reactor vessel. Alternatively, the fuel gas may be fed to gas turbines to generate power to support the production facility.

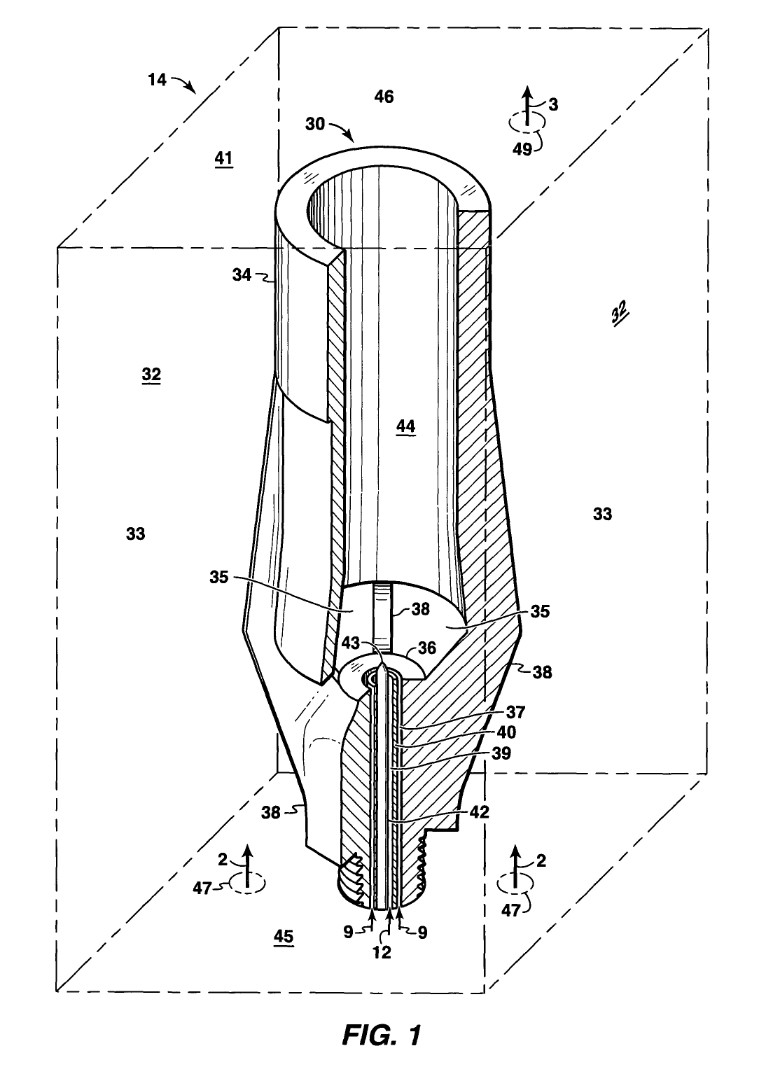

FIG. 1 depicts an embodiment of an injection reactor that may be used in some embodiments of the method of the present invention. In FIG. 1, injection reactor 14 consists of outer walls 32, upper wall 41, and lower wall 45, with ignition injector 30 centrally installed within injection reactor 14. The embodiment of FIG. 1 is simplified for descriptive purposes only. For example, ignition injector 30 is depicted in an oversize dimension compared to injection reactor 14. As will be understood to those skilled in the art, one or more ignition injectors will be employed in injection reactor 14 to achieve generally uniform upgrade reactions and reaction quenching, and the dimensional proportions of ignition injector 30 compared to injection reactor 14 will be determined from the intended throughput capacity of the upgrade facility.

The embodiment of ignition injector 30 in FIG. 1 is similar to an eduction-type mixing nozzle, preferably made with high-temperature resistant alloys, which has been fitted with a centrally located igniter 42. Ignition injector 30 comprises injector wall 34, and injector base 36. Injector base 36 is connected to injector wall 34 by injector struts 38. In this embodiment injector base 36 is connected to lower wall 45 of injection reactor 14 by screw threads. It will be understood that the method of the present invention is not limited to the use of a screw-thread connection, nor to connection of ignition injector 30 at the base of injection reactor 14, nor to the location of inlets 47 and outlet 49, which allow flow into and out of the top and bottom of injection reactor 14, respectively, and that the geometry in FIG. 1 has been chosen for exemplary purposes only. Injector conduit 40 is centrally located within injector base 36. Igniter 42 in turn is centrally located within injector conduit 40.

Heated compressed air 12 is fed into reaction chamber 44 through air input annulus 39 created between injector conduit 40 and igniter 42. Igniter 42 may be any hot-surface or sparking igniter that provides reliable ignition of gases. Heated fuel mixture 9 is fed into reaction chamber 44 through fuel input annulus 37 created between injector base 36 and injector conduit 40. Heavy oil is input into reaction chamber 44 through input slots 35, which are openings between injector struts 38 which allow flow from outer annulus 33 between outer wall 32 and ignition injector 30 to reaction chamber 44.

Tip 43 of igniter 42 ignites heated compressed air 12 and heated fuel mixture 9 to create high temperature syngas in the lower portion of reaction chamber 44 adjacent to struts 38. Heated heavy oil 2 flows into injection reactor 14 through inlets 47 in lower wall 45 and enters reaction chamber 44 through input slots 35 of ignition injector 30 and, upon contact with high temperature syngas, is rapidly subjected to a heavy oil upgrade reaction within reaction chamber 44. The flow of heated heavy oil 2 through input slots 35 results from an eduction force created from the mass momentum generated from the ignition of the gases that generates the syngas. The rapid heavy oil upgrade reaction results predominantly from the vaporization of a portion of heated heavy oil 2 when heated compressed air 12 and heated fuel mixture 9 are ignited, however, an heavy oil upgrade reaction will also occur within any unvaporized heavy oil within reaction chamber 44. Both the vaporized and any unvaporized upgraded heavy oil flow out of reaction chamber 44 into mixing chamber 46, which is the open area in injection reactor 14 below upper wall 41 but above ignition injector 30. To prevent undesirable secondary reactions, the heavy oil upgrade reaction is rapidly quenched by mixing the outflow of reaction chamber 44 with additional heated heavy oil 2 in mixing chamber 46. The additional heated heavy oil 2 flows through reactor annulus 33 to mixing chamber 46. The resulting upgraded oil mixture 3 flows out of upper wall 41 of injection reactor 14 through outlet 49 by pressure drive after a residence time in mixing chamber 46, preferably of 1 to 60 minutes, and more preferably 2 to 20 minutes, which further stabilizes upgraded oil mixture 3. Injection reactor 14 may operate under mild pressures, generally below 700 psig (4,928 kPa) and preferably below 400 psig (2,859 kPa).

The syngas generated within reaction chamber 44 will generally have a temperature above 1200° F. (649° C.) or 1225° F. (662° C.), preferably within the range of 1200 to 3000° F. (649 to 1,649° C.) or 1225 to 3000° F. (662 to 1,649° C.) and more preferably within the range of 1400° to 2400° F. (760 to 1,316° C.), to rapidly upgrade heated heavy oil 2. Natural gas is the preferred fuel for syngas generation due to its high hydrogen content. The term natural gas refers generally to gaseous hydrocarbon mixtures, for example containing such components as methane, ethane, and propane. Natural gas may also contain sulphur and trace amounts of various metals. However, any hydrogen-containing fuel source, such as liquefied petroleum gas or naphtha, may be used as fuel for syngas generation. Alternatively heavy feeds such as the heavy crude itself, petroleum residual oils and cokes may be used to generate syngas for upgrading.

The reaction time in reaction chamber 44 will preferably be ten seconds or less, and more preferably less than 2 seconds, to limit secondary cracking reactions. The velocities of heated fuel mixture 9 and heated compressed air 12 into reaction chamber 44 should preferably be relatively high to prevent damage to ignition injector 30 from the ignition reaction that creates the syngas. A minimum velocity of 10 ft/sec (3 m/s) is preferred, although, depending on the alloy from which ignition injector 30 is fabricated, lower velocities may be used. Depending on the velocities used, the reaction zone of the heavy oil upgrade reaction may extend beyond the lower portion of reaction chamber 44, and possibly into chamber 46.

A preferred ignition injector is an eduction-type injection nozzle, as depicted in FIG. 1, that has a conical shaped chamber to facilitate both the ignition of heated compressed air 12 and heated fuel mixture 9, and the cracking of the heavy oil molecular bonds. In the design depicted in FIG. 1, with a centrally-located igniter installed within the injection nozzle, the partial oxidation reaction is believed to primarily occur at the center of reaction chamber 44, with a portion of heated heavy oil 2 flowing along the inner surface of injector wall 34, thereby serving as a protective film for the inside surface of injector wall 34.

It will be understood that injector 30 and igniter 42 are not necessarily limited to the geometry of the embodiment depicted in FIG. 1. Although a coannular-type injector is preferred to achieve fast ignition of the fuel and air mixture and to avoid flashback, any injection igniter that is capable of generating syngas without injector damage can be used in this embodiment. Furthermore, instead of inputting heated compressed air 12 and heated fuel mixture 9 through concentric annuli within injector base 36, separate input lines could used to input heated compressed air 12 and heated fuel mixture 9 into reaction chamber 44. Similarly, heated heavy oil 2 could be input through a separate, nonconcentric input line. Depending on the geometry and length of injector wall 34, heated heavy oil 2 could be input to the upper portion of reaction chamber 44 through slots in the top of injector wall 34, thereby further facilitating the reaction quenching. Each of the examples in this paragraph are not depicted in FIG. 1, but will be understood to one skilled in the art, who will also recognize other implementation examples of suitable ignition injectors based on the teachings of this description.

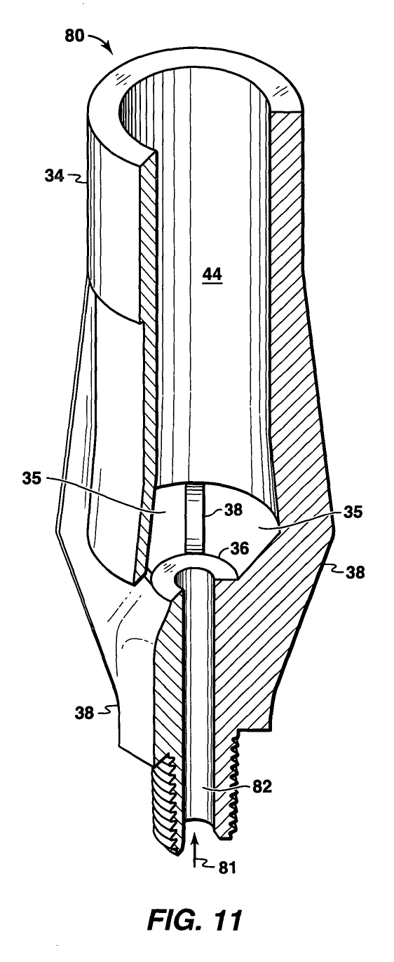

FIG. 11 depicts one embodiment of an injector nozzle 30 that may be used in embodiments of the invention. The injector nozzle 30 of FIG. 11 may be used where syngas is formed in a separate partial oxidation reaction chamber and transferred to a separate heavy oil upgrading reaction chamber as described in more detail later herein. The main difference between the injector nozzle 30 of FIG. 11 and that of FIG. 1 is that the injector nozzle 30 of FIG. 11 does not contain an igniter and separate fuel and oxidizer input passages as depicted in FIG. 1. The nozzle of FIG. 11 contains one syngas passage 82 for transferring syngas 81 to a point where such syngas is contacted with heavy oil entering through input slots 35, which are openings between injector struts 38.

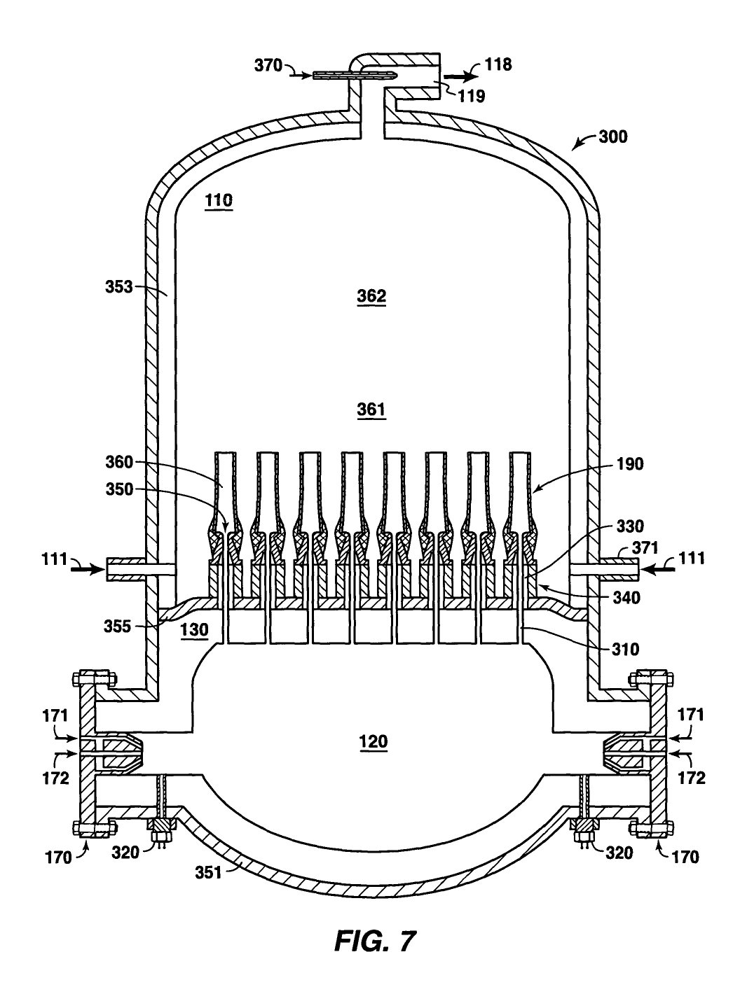

In another embodiment, the heavy oil upgrading reactor is composed of two reaction chambers. A partial oxidation reaction chamber (pox chamber) is provided for the generation of a hydrogen-containing gas, for example, syngas and a heavy oil upgrading reaction chamber is provided for heavy oil upgrading. In one embodiment the two reaction chambers are integrated. FIG. 7 depicts one embodiment of an integrated heavy oil upgrading reactor 300. The partial oxidation reaction chamber 120 may be the bottom section and may be refractory lined 130. In the partial oxidation reaction chamber 120 syngas may be generated from a hydrocarbon fuel source 171, air 172 and optionally steam. The top section may be a heavy oil upgrading reaction chamber 110 where heavy oil 111 is upgraded and may be refractory lined 353. The two reaction chambers may be connected through one or multiple refractory lined 330 conduits 310.

Syngas may be generated in the partial oxidation reaction chamber 120 by combusting a hydrocarbon fuel 171 with an oxidizing agent, for example air 172. The partial oxidation reaction may alternatively include the addition of steam. Syngas may alternatively be generated from partial oxidation of a hydrocarbon fuel 171 and steam mixture with air 172 under pressure. The hydrocarbon fuel 171 and steam mixture may be preheated to a temperature in the range of 300-1,500° F. (149-816° C.), alternatively to 350-1000° F. (149-538° C.) or 400-600° F. (204-316° C.). Compressed air or alternatively enriched air may be preheated to 200-1,500° F. (93-816° C.) or alternatively 225-1000° F. (107-538° C.) or 250-750° F. (121-399° C.), before reacting with hydrocarbon fuel 171 and steam in the partial oxidation reaction chamber 120. A portion of the feed steam can alternatively be introduced to the compressed air feeding system. As discussed previously the oxidizing agent, may be, for example, air, enriched air or pure oxygen and, the fuel may be any gaseous or liquid hydrocarbon, but is preferably natural gas. For example the hydrocarbon fuel can be natural gas, natural gas liquid, light naphtha, naphtha, or distillate fuel. In one embodiment, the partial oxidation reaction may be accomplished using only air as an oxidizing agent, thus lessening the oxidizing agent cost as compared to enriched air or pure oxygen. Additionally, the partial oxidation reaction may be accomplished with the addition of less steam than used in other systems, thus reducing the amount of waste water produced in the overall process and resulting in a higher syngas temperature. In some embodiments the steam to hydrocarbon fuel molar ratio may be from 0.25:1 to 10:1. Alternatively the steam to fuel molar ratio may be from 0.25:1 to 3:1, 0.3:1 to 2.5:1, 0.5:1 to 2:1 or 0.75:1 to 1.5:1.

Multiple injectors 170 may be used to feed hydrocarbon fuel 171, steam, and air 172 to the partial oxidation reaction chamber 120. It is preferable to use face-mixing injectors to achieve lower flame temperature and to accommodate a compact partial oxidation reaction chamber 120 size. Each face-mixing injector may optionally contain multiple orifices to introduce multiple face-mixed jets to the partial oxidation reaction chamber 120. An ignition system, for example an igniter 320, may be integrated into the pox chamber 120 to initiate the partial oxidation reactions. The igniter 320 can be, for example, a sparking igniter or hot surface igniter.

Since the partial oxidation reactor chamber is able to operate at steam to fuel ratios near 1:1, air may be used as an oxidizing agent while still reaching a syngas temperature above 1200° F. (649° C.) or 1225° F. (662° C.). In alternative embodiments the syngas temperature may be within the range of 1200 to 3000° F. (649 to 1,649° C.), 1225 to 3000° F. (662 to 1,649° C.) or within the range of 1400° to 2410° F. (760 to 1,316° C.). Embodiments of the partial oxidation reaction may be carried out below 700 psig (4,928 kPa) and more preferably below 500 psig (3,549 kPa).

Syngas may be transferred to the heavy oil upgrading reaction chamber 110 through one or more conduits 310, which may be refractory lined 330. Each refractory lined 330 conduit 310 may be linked to a stool 340 for connection of an eduction nozzle 190. Stools 340 may be mounted on a steel supporting plate 355 that may be welded to the shell 351 of the pox reaction chamber 120. The supporting plate may be curved around the edge to allow for thermal expansion. The stool 340 may include an internal passage and may also be refractory lined to sustain high temperature operation. The inlet port 350 of the eduction nozzle 190 where syngas is injected is preferably refractory lined for longevity of operations. High temperature alloys can be used as the construction material of the eduction nozzles 190 without the protection of ceramic lining when syngas temperature is below about 2,000° F. (1093° C.).

In one embodiment, the eduction nozzles 190 terminate in the heavy oil upgrading reaction chamber 110. The eduction nozzles 190 may be designed to be mostly or completely housed within the heavy oil upgrading reaction chamber 110. In one embodiment, the heavy oil upgrading reaction chamber 110 may include three zones. The high temperature reaction zone 360 includes contacting the heavy oil feed with hot syngas at a temperature in excess of 1200° F. (649° C.) or alternatively above 1225° F. (662° C.) for less than 10 seconds or alternatively less than 2 seconds. In alternative embodiments the high temperature reaction zone 360 temperature may be within the range of 1200 to 3000° F. (649 to 1,649° C.), 1225° F. to 3000° F. (662° C. to 1,649° C.) to or within the range of 1400° to 2400° F. (760 to 1,316° C.). The high temperature reaction zone 360 may be completely, principally or partially located within the eduction nozzle 190.

The heavy oil upgrading reaction chamber 110 may also contain a rapid quench zone 361 where the thermally cracked oil from the high temperature reaction zone 360 is quickly quenched to reduce its temperature and terminate the rapid high temperature thermal cracking of the heavy oil feed. In the rapid quench zone 361 the thermally cracked oil's temperature is reduced from over 1200° F. (649° C.) or alternatively above 1225° F. (662° C.) to below 850° F. (454° C.) and alternatively below 800° F. (427° C.) within 10 seconds of the initiation of the high temperature thermal cracking of the heavy oil feed. The rapid quench zone 361 may be principally or partially within the eduction nozzle 190 and principally, partially or completely outside of the nozzle 190 in the heavy oil upgrading reaction chamber 110. In one embodiment, unreacted heavy oil may serve as the quenching medium. In one embodiment the quench medium is unvaporized, unreacted, cooler heavy oil that was part of the heavy oil feed to the eduction nozzle 190, but was not intimately contacted with the hot syngas and therefor not vaporized. The cooler, unreacted heavy oil feed may have flowed along the inner wall of the eduction nozzle 190 and therefore escaped intimate contact with the syngas.

The heavy oil upgrading reaction chamber 110 may also contain a stabilization zone 362 where the cooled thermally cracked oil that has been mixed with the quenching medium is allowed to stabilize for 1 to 60 minutes, alternatively 20 to 50 minutes. The stabilization zone 362 may be operated below 850° F. (454° C.) and alternatively below 800° F. (427° C.) or from 740-790° F. (393-421° C.) so that rapid thermal cracking is reduced or eliminated. However, the stabilization zone 362 may further contribute to the oil upgrading process. In embodiments of the invention the stabilization zone 362 may account for over 30 percent, alternatively over 40 or 50 percent, of the overall process heavy oil conversion. Conversion is defined as the percentage by weight of feed to the process that boils over 1050° F. that is converted to material that boils below 1050° F. That is upgrading or conversion is defined as:

Conversion=((Feed wt. % 105° F.+)−(Product wt. % 1050° F.+))/(Feed wt. % 1050° F.+).

Temperature and residence time impact on the stability and upgrading of oil in the stabilization zone 362. Reaction severity index (RSI_{875° F.}) based on a reference temperature of 875° F. (468° C.) may be applied to monitor the influence of residence time on stability of the upgraded oil. RSI_{875° F.} is defined as:

RSI_{875° F.}=(stabilization time)×e^{(E/R)(1/(875+460)-1/(T+460))}

Where: (stabilization time) is in seconds

E=activation energy (cal/mole)

R=gas law constant (cal/(mole-° K)

T=reaction temperature (° F.)

In embodiments of the invention the RSI_{875° F.} of the upgraded crude may be kept below 300 seconds and alternatively below 250, 200 or 150 seconds. In embodiments of the invention the RSI_{875° F.} of the upgraded crude may be kept above 5 seconds and alternatively above 10 or 20 seconds. Therefore, the volume of the stabilization zone 362 may be sized to ensure the stability of the upgraded crude. Alternatively, water 370 can be injected, either in the stabilization zone 362 or in the reactor exit pipe 119, to further cool the upgraded crude. In the case of water injection, it is desirable to cool down the upgraded crude to below 750° F. (399° C.) and more preferably below 700° F. (371° C.).

The heavy oil upgrading reaction chamber 110 may be operated at various pressures in excess of 1000 psig or in a low pressure mode. In low pressure mode, the heavy oil upgrading reaction chamber 110 is operated below 700 psig (4,928 kPa) or below 500 psig (3,549 kPa). The heavy oil upgrading reaction chamber 110 may alternatively be operated in the range of 200 psig (1480 kPa) to 600 psig (4,238 kPa). In such operation the hydrogen partial pressure within the reaction chamber may range from 20 psia (138 kPa) to 200 psia (1379 kPa) or alternatively from 40 psia (276 kPa) to 120 psia (827 kPa) or 40 psia (276 kPa) to 115 psia (793 kPa).

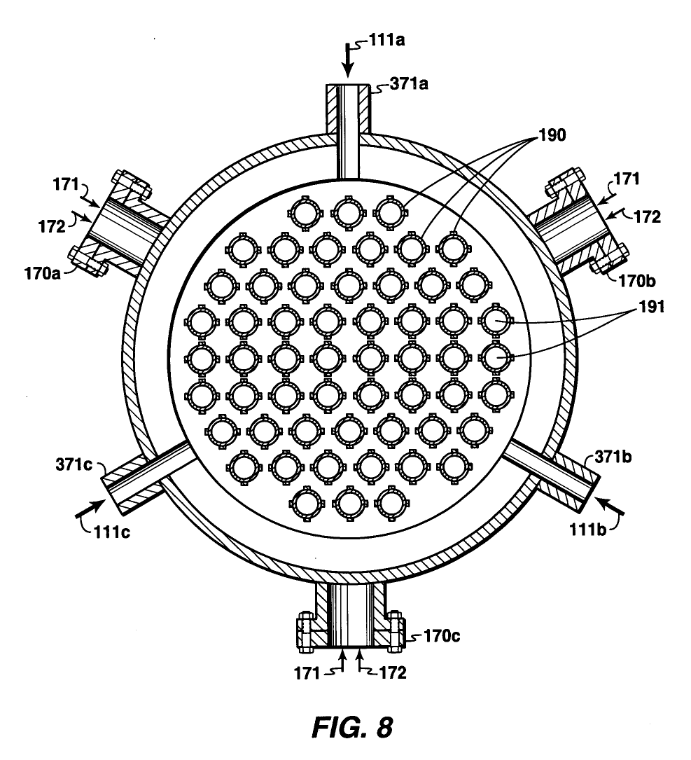

Preheated heavy oil 111 may be fed to the heavy oil upgrading reaction chamber 110 through multiple inlets 371 located at the bottom portion of the chamber 110. FIG. 8 shows three heavy oil inlets 371 a-c that are 120° apart from each other, however the number of heavy oil inlets 371 is not limited to three. Alternatively an internal pipe distribution system may be used at the bottom of the heavy oil upgrading reaction chamber 110 to distribute heavy oil feed uniformly. The temperature of the preheated heavy oil 111 a-c can vary but is preferably between 300 and 800° F. (149 and 427° C.) and more preferably between 400 to 600° F. (204 and 316° C.).

Natural gravity force and eduction force created by the injected syngas within the eduction nozzle may drive a portion, 20-50%, of the preheated heavy oil into the eduction nozzles through openings located close to the bottom of nozzles. This portion of heavy oil is rapidly cracked and vaporized once it contacts hot syngas in the internal compartment of the eduction nozzles. It is likely that a certain amount of heavy oil flowing upward along the inner wall of the eduction nozzles will undergo cracking reactions in the liquid phase; however it is believed that the majority of the heavy oil in the eduction nozzles goes through gas phase cracking reactions. Hydrogen in the syngas performs the function of radical capping to minimize retrogressive reactions that form coke. The residence time of the gas phase cracking reactions is preferably below 10 seconds, and more preferably below 2 seconds, to minimize the yield of light hydrocarbon gases. Cracking products exit the nozzles and are immediately in contact with the remaining portion, 50-80%, of heavy oil and/or recycled, cooled thermally cracked oil that bypasses the eduction nozzles. Cracking products are mixed with the bypassed heavy oil by turbulent forces and cooled down quickly in the rapid quench zone of the heavy oil upgrading reaction chamber. The fast quenching of cracking products will minimize secondary cracking and coking reactions. Above the rapid quench zone is the stabilization zone where cracking products are completely mixed with unreacted heavy oil and chemical equilibrium is reached.

Alternatively, the entire feed of heavy oil, along with some amount of fluids contained within the heavy oil upgrading reaction chamber (e.g. cooled thermally cracked oil, quenched oil and/or stabilized oil), may be fed to the eduction nozzle by creating a strong eduction force with a high velocity flow of syngas within the eduction nozzle. In this embodiment the mixture of heavy oil feed and other reactor fluids may serve as the quench medium within the eduction nozzle. In differing embodiments the amount of recycled reaction chamber fluids educed into the eduction nozzle may be varied by adjusting the syngas velocity within the eduction nozzle and by adjusting the fresh heavy oil feed and stabilized oil product withdrawal flow rates. In this way uncracked or partially cracked heavy oil may be recycled several passes through the eduction nozzle and high temperature reaction zone for additional upgrading. In various embodiments the total feed rate to the eduction nozzle(s) may be greater than 2, 5, or 10 times the fresh heavy oil feed rate to the heavy oil reaction chamber.

Various embodiments of the current invention provide a process that produces lower light gas yield than other available processes. For example, embodiments of the current invention may produce less than 4 wt. % of C₁-C₄ gas. Alternatively, embodiments of the invention produce less than 3, 2 or 1 wt. % of C₁-C₄ gas. In addition embodiments of the invention produce less than 2 wt. % of coke, alternatively less than 1 wt. %, less than 0.5 wt. %, or less than 0.1 wt. % coke.

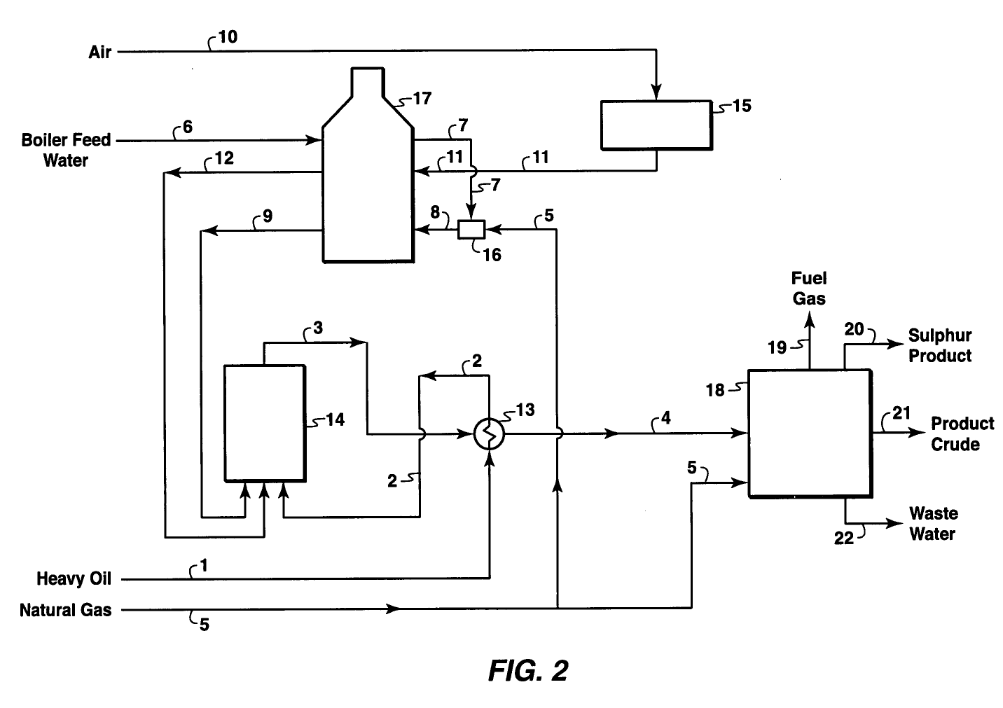

FIG. 2 depicts a simplified process schematic of one embodiment of the invention that may be used with the various reactor configurations discussed herein. Heavy crude 1 from any source is preheated in heat exchanger 13 to generate heated heavy oil 2, which is input into injection reactor 14, or alternatively heavy oil upgrading reaction chamber. The temperature of heated heavy oil 2 is preferably low enough to minimize thermal cracking of the oil molecules, and for most heavy oil will range from 300 to 800° F. (149 to 427° C.), and more preferably from 400 to 700° F. (204 to 371° C.).

Air 10 is compressed in air compressor 15. Compressed air 11 is heated in furnace 17 to a temperature preferably between 200 and 1000° F. (93 to 538° C.), and more preferably between 250 and 800° F. (121 to 427° C.). Heated compressed air 12 is then input to injection reactor 14. As noted above, other sources of oxygen molecules may be used. It will be understood that preheating of heavy crude 1 or compressed air 11 are not requirements of the present invention, but are preferable to increase the efficiency of the upgrade reaction. Steam 7 is created from the heating of boiler feed water 6 in furnace 17. Natural gas 5 mixes with steam 7 in mixer 16, and is heated in furnace 17 to a temperature preferably between 300 and 1000° F. (149 to 538° C.). The heated fuel mixture 9 that results is input to injection reactor 14, or alternatively into a heavy oil upgrading reaction chamber of a two reactor chamber reactor.

As described above in conjunction with FIG. 1, ignition of heated compressed air 12 and heated fuel mixture 9 in the presence of heated heavy oil 2 may be used to initiate the upgrade reaction or syngas may be generated in a separate pox reaction chamber and transferred hot to a separate heavy oil upgrading reaction chamber as described herein. In the first reactor embodiment, it is preferable if multiple ignition injectors 30 are uniformly spaced within injection reactor 14 to facilitate the maximum throughput and efficiency of the upgrade facility. The exact number of ignition injectors 30 will depend on the size of injection reactor 14 and the desired throughput volume of the upgrade facility. Also as described above, the output of injection reactor 14 is upgraded oil mixture 3.

A small amount of solid materials, preferably less than five weight percent, may optionally be mixed (not shown in the drawings) with heated heavy oil 2 before it is input to injection reactor 14, or alternatively the heavy oil upgrading reaction chamber of a two chamber reactor, to control potential deposits within injection reactor 14. These solids can be either inert, such as sand, or reactive, such as coal.

In this embodiment, upgraded oil mixture 3 is used as a heat source for heat exchanger 13. Cooled upgraded heavy oil 4 is then input to a conventional separator 18, which produces product crude 21, fuel gas 19, sulfur product 20, and waste water 2.

To fully appreciate the present invention, it is useful to contrast the PCU process with the manner in which previously proposed methods upgrade heavy oil. The variety of previously proposed methods have been directed to a liquid phase heavy oil upgrade reaction in which the molecular bonds in liquid phase heavy oil are broken and the resulting carbon radicals combined with available hydrogen radicals to create a stabilized upgraded heavy oil.

In contrast, one embodiment of the PCU process focuses on a predominantly gas phase heavy oil upgrade reaction. Specifically, heat released during the formation of syngas vaporizes a portion of heavy oil, thereby allowing a gas phase heavy oil upgrade reaction to occur. This vaporization and gas phase reaction occurs much more quickly than does a liquid phase reaction, with the hydrogen within the syngas simultaneously available to bond with the heavy oil's carbon atoms. Although the process may be carried out at high pressures, high pressures are not necessary to facilitate this gas phase reaction, thereby allowing lower pressures to be used if desired. In addition, hydrogen and carbon molecules bond more readily in the gas phase, further facilitating short upgrade reaction times and high upgrade process efficiencies.

Because the PCU process' gas phase upgrade reaction occurs quickly, a method of rapidly quenching the upgraded heavy oil is also necessary. Because the temperature differential between the upgraded vaporized heavy oil and the un-upgraded heavy oil is large, additional un-upgraded heavy oil quickly quenches the upgrade reaction and thereby prevents the generation of unwanted waste materials. The temperature differential is much less in liquid phase techniques, and therefore the reactions in those techniques cannot be quenched as quickly and unwanted waste materials cannot be avoided to the same extent as in the PCU process.

Embodiments of applicant's invention may take advantage of presently available components to facilitate fabrication of reliable heavy oil upgrade facilities. For example, nozzles which have long been used to circulate and mix fluids in closed and open tanks may be used. One example of nozzles which may be used or modified to meet the requirements of an ignition injector or eduction nozzle used in embodiments of the invention are the TurboMix™ products of BETE Fog Nozzle, Inc. of Greenfield, Mass. Similarly, igniter 42 used in some embodiments of the invention may be based on hot surface igniters which have long been used in gas appliances. For example, the MINI-IGNITER line of products of Saint-Goban/Advanced Ceramics-Norton Igniter Products of Milford, Mass. could be modified to meet the needs of the PCU process. Advantages of hot surface igniters, as compared to sparking-type igniters, include low input power requirements and safer operation. The ability of Applicants' invention to build on presently available technologies and component parts—in each case from diverse and previously unrelated areas of commerce—is a unique characteristic of the PCU process and an important advance over previously proposed heavy oil upgrade processes.

In distinguishing the PCU process from previously disclosed methods, applicants are not bound by any specific physical, chemical, or mechanical theory of operation. Applicants have set forth these theories in an effort to explain how and why the invention is believed to work. These theories are set forth for informational purposes only, and are not to be interpreted as limiting in any way the true spirit and scope of the present invention.

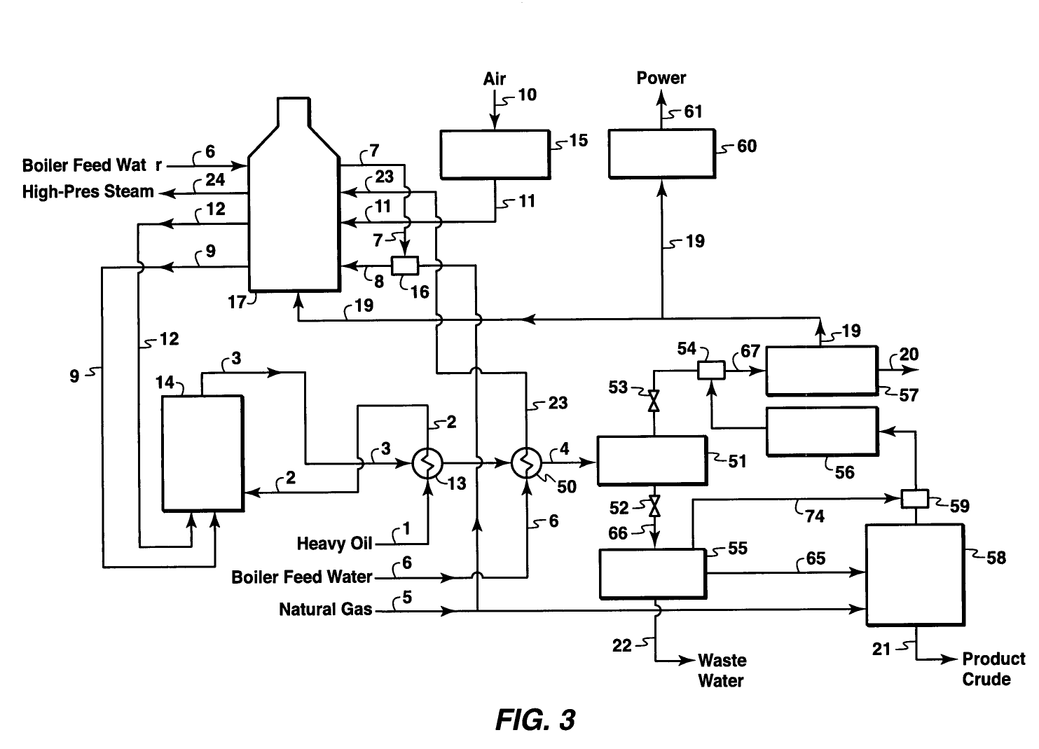

A second embodiment of the PCU process is shown in FIG. 3. This embodiment provides an example of the upgrade efficiencies that result from implementation of the PCU process. In FIG. 3 the operation of heat exchanger 13, injection reactor 14 or alternatively the heavy oil upgrading reaction chamber of a two chamber reactor, air compressor 15, mixer 16, and furnace 17 are as described above.

In this configuration, upgraded oil mixture 3 is subjected to a second heat exchanger 50 for further cooling before being input as cooled upgraded heavy oil 4 to gas-liquid separator 51. An efficiency of this implementation is that boiler feed water 6 can be used as the cooling medium for heat exchanger 50, with heated boiler feed water 23 then being input to furnace 17. The result is a second source of water to furnace 17 to generate steam 7, or, alternately, to generate a separate high-pressure steam supply 24 for such applications as enhanced oil recovery.

Gases separated from gas-liquid separator 51 are sent through an expansion device, such as a Joule-Thomson valve, 53 and mixer 54 before being input as gas 67 to gas treating unit 57. The output of gas treating unit 57 is fuel gas 19 and sulfur product 20. In this embodiment, sulfur product 20 will most likely be hydrogen sulfide gas, as will be understood to those skilled in the art. As a result, product crude 21 will have a lower sulfur content than does heavy oil 1. Another efficiency of this embodiment is that fuel gas 19 can be used as power source for furnace 17, and, or in the alternative, as power source for turbine 60 to generate power 61.

Liquids separated from gas-liquid separator 51 are sent through expansion device 52 to generate liquid product 66, which is input to liquids separator 55. Waste water 22, if generated, results from liquids separator 55. Any extraneous gas 74 not previously separated is sent to mixer 59, where it mixes with gas withdrawn from stripping tower 58. That mixture is compressed in tail gas compressor 56, and input to mixer 54. Hydrocarbon liquids 65 from separator 55 are sent to stripping tower 58 to generate product crude 21.

Process simulations of the PCU process have been carried out. Numerous process simulation-modeling programs are commercially available; one example is the HYSYS™ program, version 2.2, a product of Hyprotech Ltd., a subsidiary of AEA Technology plc. Other such programs will be known to those skilled in the art. Table 1 provides typical operating temperatures, pressures, and flow rates at various stages of the PCU process, and is cross-referenced to the reference numbers in FIG. 3. For simplicity, the process simulation results depicted in Table 1 used an assumed mixture of heavy paraffins and sulfur-containing paraffinic compounds to represent heavy oil 1. Specifically, a mixture of 50% of n-C₃₀H₆₂ and 50% of n-C₃₀H₆₁SH was assumed to represent heavy oil. The simulations assumed that a 40% portion of the heavy oil input stream reacted with syngas for complete conversion into cracked products via the following two reactions:

n-C₃₀H₆₁SH+H₂−>n-C₃₀H₆₂+H₂S 1)

n-C₃₀H₆₂+x H₂−>Cracked products 2)

The cracked products were assumed to be mixture of compounds having individual carbon sequences ranging from 1 to 22 carbon molecules long. The assumed cracking chemistry yields 6.6% of gases with one to four carbon molecules and the overall hydrogen consumption is 268 scf/bbl. Sensitivity tests were performed for mixtures having assumed carbon sequences ranging from 1 to 28 molecules long, and with a cracking gas yield of 4.7% and overall hydrogen consumption of 230 scf/bbl, without substantial differences from the results summarized below.

The simulation assumed that 10% of the carbon monoxide within the syngas reacts with water to form additional hydrogen molecules for bonding with the heavy oil radicals. The simulation assumed that the unreacted 60% of the heavy oil input stream was used to quench the upgrade reaction.

The simulation results in Table 1 demonstrate the benefits of the PCU process. The 0.6 ratio of steam 7 to natural gas 5 is lower than is required in previously disclosed heavy oil upgrade techniques. As a result, the process generates a low volume of wastewater 22. In addition, product crude 21 does not suffer output volume reductions that are typical of many heavy oil upgrade techniques. Product crude 21, which consists of a mixture on a mole-percent basis of 61.8% of cracked heavy oil components and 38.2% of uncracked heavy oil, has been upgraded by API 6.8 in comparison to heavy oil 1.

TABLE 1
Simulation Results for PCU Process Embodiment of FIG. 3

| | | | | | | | Oil |
|---|---|---|---|---|---|---|---|
| Process | Flow | Flow Volume | Temperature | Temperature | Pressure | Pressure | Quality |
| Reference | Volume | Kg mole/hr | ° F. | ° C. | psia | Kpa | API |
| Heavy Oil 1 | 40,000 | 528.4 | 199.5 | 93.1 | 169 | 1,165 | 32.8 |
| | bbl/day | | | | | | |
| Natural Gas 5 | 9.1 mscf/day | 453.6 | 80 | 26.7 | 178.5 | 1,231 | |
| Input to Mixer 16 | | | | | | | |
| Steam 7 | 10,810 lb/hr | 272.2 | 372.8 | 189.3 | 178.5 | 1,231 | |
| Heated Boiler | 551,000 lb/hr | 13,870 | 357.2 | 180.7 | 1520 | 10,480 | |
| Feed Water 23 | | | | | | | |
| Heated | 96,400 lb/hr | 1,518 | 1050 | 565.6 | 177 | 1,220 | |
| Compressed Air | | | | | | | |
| 12 | | | | | | | |
| Heated Fuel | 27,830 lb/hr | 725.8 | 1050 | 565.6 | 177 | 1,220 | |
| Mixture 9 | | | | | | | |
| Syngas | 124,230 lb/hr | 2,768 | 2237 | 1,225 | 167 | 1,151 | |
| Generated within | | | | | | | |
| Injection Reactor | | | | | | | |
| 14 | | | | | | | |
| Heated Heavy | 40,000 | 528.4 | 500 | 260 | 167 | 1,151 | |
| Oil 2c | bbl/day | | | | | | |
| Upgraded Heavy | 635,400 lb/hr | 3,295 | 752.8 | 400.2 | 160 | 1,103 | |
| Oil 3 | | | | | | | |
| Cooled Upgraded | 635,400 lb/hr | 3,295 | 120 | 48.9 | 112.5 | 776 | |
| Heavy Oil 4 | | | | | | | |
| Liquid Product | 507,600 lb/hr | 1,255 | 118.9 | 48.3 | 14.8 | 102 | |
| 66 | | | | | | | |
| Sour Crude 65 | 40,840 | 846.1 | 118.9 | 48.3 | 14.8 | 102 | |
| | bbl/day | | | | | | |
| Natural Gas 5 | 910 kscf/day | 45.4 | 69.2 | 20.7 | 15.8 | 109 | |
| Input to Stripping | | | | | | | |
| Tower 58 | | | | | | | |
| Gas 67 | 135,600 lb/hr | 2,147 | 110 | 43.3 | 45 | 310 | |
| Wastewater 22 | 991 bbl/day | 363.6 | 118.9 | 48.3 | 14.8 | 102 | |
| Exhaust Gas | 279 | 13,880 | 505.8 | 263.2 | 14.8 | 102 | |
| from Furnace 17 | mscf/day | | | | | | |
| Product Crude 21 | 40,620 | 829.3 | 117.4 | 47.4 | 15.8 | 109 | 39.6 |
| | bbl/day | | | | | | |

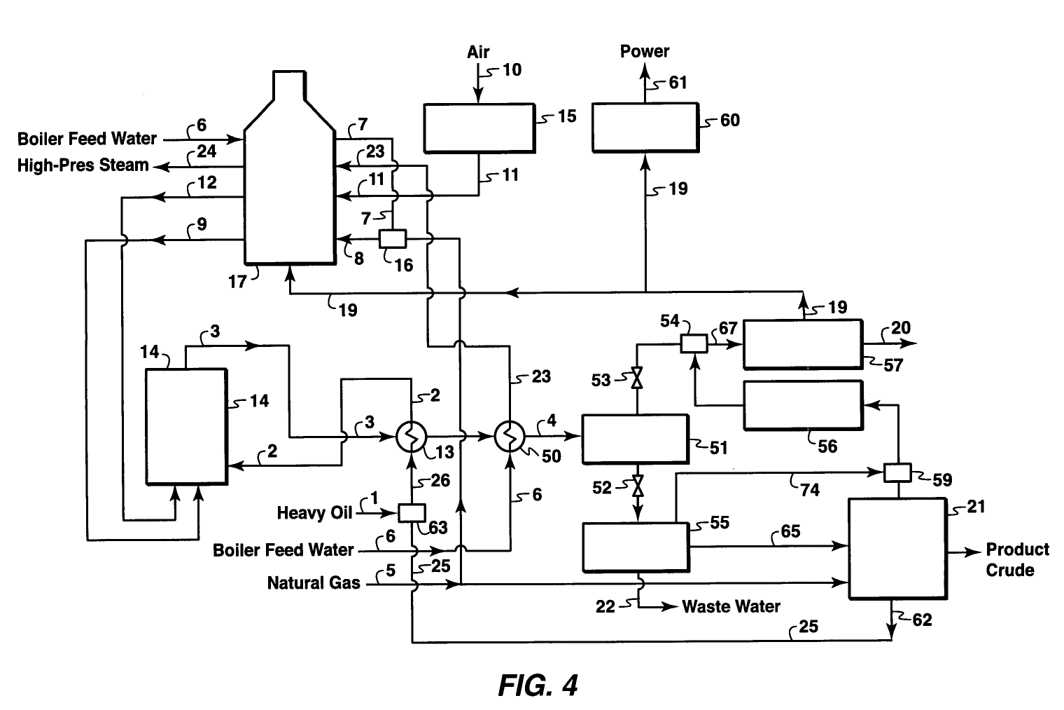

FIG. 4 depicts an embodiment of the PCU process similar to the embodiment of FIG. 3, except that distillation tower 62 replaces stripping tower 58 and a portion of unreacted heavy oil 25 is recycled back to injection reactor 14 by mixing with heavy oil 1 in mixer 63. In simulations of this embodiment 20% of the unreacted heavy oil from distillation tower 62 is recycled, although the embodiment is not limited to the recycling of any specified percentage of unreacted heavy oil from the distillation tower. Mixed heavy oil 26 is heated in heat exchanger 13 before being input to injection reactor 14. The simulation again assumes 40% of the heated heavy oil 2 reacts with syngas and the remaining 60% is the quenching material. The results of the simulation of this embodiment are depicted in Table 2. Note that product crude 21 has a significantly higher API gravity than in the embodiment of FIG. 3. In this embodiment product crude 21 contains 66.9 mole-percent cracked heavy oil components.

TABLE 2
Simulation Results for Recycled Heavy Oil PCU Process Embodiment of FIG. 4

| | | | | | | | Oil |
|---|---|---|---|---|---|---|---|
| Process | Flow | Flow Volume | Temperature | Temperature | Pressure | Pressure | Quality |
| Reference | Volume | Kg mole/hr | ° F. | ° C. | psia | kpa | API |
| Heavy Oil 1 | 40,000 | 528.4 | 199.5 | 93.1 | 169 | 1,165 | 32.8 |
| | bbl/day | | | | | | |
| Recycled Heavy | 5,454 | 72.0 | 200 | 93.3 | 169 | 1,165 | |
| Oil 25 | bbl/day | | | | | | |
| Natural Gas 5 | 10.4 | 517.1 | 80 | 26.7 | 178.5 | 1,231 | |
| Input to Mixer 16 | mscf/day | | | | | | |
| Steam 7 | 12,320 lb/hr | 310.3 | 372.8 | 189.3 | 178.5 | 1,231 | |
| Heated Boiler | 626,500 lb/hr | 15,770 | 357.7 | 180.9 | 1520 | 10,480 | |
| Feed Water 23 | | | | | | | |
| Heated | 109,900 lb/hr | 1,730 | 1050 | 565.6 | 177 | 1,220 | |
| Compressed Air | | | | | | | |
| 12 | | | | | | | |
| Heated Fuel | 31,730 lb/hr | 827.4 | 1050 | 565.6 | 177 | 1,220 | |
| Mixture 9 | | | | | | | |
| Syngas | 141,630 lb/hr | 3,155 | 2237 | 1,225 | 167 | 1,151 | |
| Generated within | | | | | | | |
| Injection Reactor | | | | | | | |
| 14 | | | | | | | |
| Heated Heavy | 40,000 | 528.4 | 500 | 260 | 167 | 1,151 | |
| Oil 2 | bbl/day | | | | | | |
| Upgraded Heavy | 722,500 lb/hr | 3,754 | 752.9 | 400.5 | 160 | 1,103 | |
| Oil 3 | | | | | | | |
| Cooled Upgraded | 722,500 lb/hr | 3,754 | 120 | 48.9 | 112.5 | 776 | |
| Heavy Oil 4 | | | | | | | |
| Liquid Product | 576,800 lb/hr | 1,427 | 118.9 | 48.3 | 14.8 | 102 | |
| 66 | | | | | | | |
| Sour Crude 65 | 556,100 lb/hr | 961.4 | 118.9 | 48.3 | 14.8 | 102 | |
| Natural Gas 5 | 1.0 mscf/day | 49.9 | 69.2 | 20.7 | 15.8 | 109 | |
| Input to Stripping | | | | | | | |
| Tower 58 | | | | | | | |
| Gas 67 | 154,400 lb/hr | 2,447 | 110 | 43.3 | 45 | 310 | |
| Wastewater 22 | 1,130 | 414.5 | 118.9 | 48.3 | 14.8 | 102 | |
| | bbl/day | | | | | | |
| Exhaust Gas | 310 | 15,580 | 506.3 | 263.5 | 14.8 | 102 | |
| from Furnace 17 | mscf/day | | | | | | |
| Product Crude 21 | 40,710 | 870.7 | 118 | 47.8 | 15.8 | 109 | 56.6 |
| | bbl/day | | | | | | |

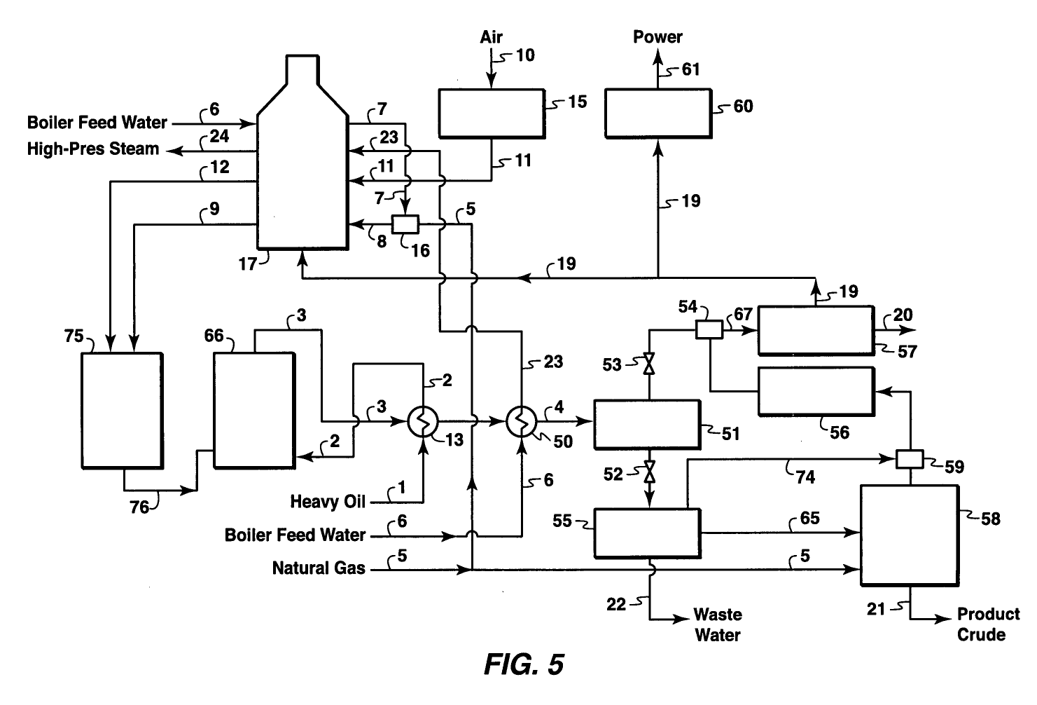

Another embodiment is depicted in FIG. 5. In this embodiment injection reactor 14 in replaced by partial oxidation (POX) reactor 75 and upgrade reactor 66. Partial oxidation refers to the process of limiting the amount of oxygen that is allowed to react with the fuel mixture so as to ensure that the preponderance of the output products are hydrogen and carbon monoxide, and not carbon dioxide and water. POX reactors are well known in the gas-to-liquids conversion field, as well as in other fields, and this embodiment provides an example of the implementation of the PCU process using well-understood commercially available components. Heated fuel mixture 9 and heated compressed air 12 are fed to partial oxidation reactor 75 to generate syngas 76. Hot syngas 76 is sent through a set of injection nozzles (not depicted) located in upgrade reactor 66. In this embodiment, a high steam to natural gas ratio is used in heated fuel mixture 9 to keep syngas 76 at an approximate temperature of 1400° F. (760° C.). This prevents high temperature damage to the flow line and nozzles used to transfer syngas 76 to upgrade reactor 66. This approximate temperature is not a limitation of this embodiment, but rather is a function of the temperature resistance of the materials used to fabricate the components of the upgrade facility. Simulations of this embodiment again assume 40% of heated heavy oil 2 reacts with syngas and the remaining 60% is the quenching material. Product crude 21 contains 60.7 mole-percent cracked heavy oil, and has an API gravity improvement of 8.4.

TABLE 3
Simulation Results for POX Reactor PCU Process Embodiment of FIG. 5

| | | | | | | | Oil |
|---|---|---|---|---|---|---|---|
| Process | Flow | Flow Volume | Temperature | Temperature | Pressure | Pressure | Quality |
| Reference | Volume | Kg mole/hr | ° F. | ° C. | psia | Kpa | API |
| Heavy Oil 1 | 40,000 | 528.4 | 199.5 | 93.1 | 169 | 1,165 | 32.8 |
| | bbl/day | | | | | | |
| Natural Gas 5 | 20.0 | 997.9 | 80 | 26.7 | 178.5 | 1,231 | |
| Input to Mixer 16 | mscf/day | | | | | | |
| Steam 7 | 150,600 lb/hr | 3,792 | 372.8 | 189.3 | 178.5 | 1,231 | |
| Heated Boiler | 930,000 lb/hr | 23,420 | 450.1 | 232.3 | 1520 | 10,480 | |
| Feed Water 23 | | | | | | | |
| Heated | 154,200 lb/hr | 2,429 | 800 | 426.7 | 177 | 1,220 | |
| Compressed Air | | | | | | | |
| 12 | | | | | | | |
| Heated Fuel | 188,050 lb/hr | 4,790 | 800 | 426.7 | 177 | 1,220 | |
| Mixture 9 | | | | | | | |
| Syngas 76 | 342,250 lb/hr | 8,223 | 1401 | 760.8 | 167 | 1,151 | |
| Heated Heavy | 40,000 | 528.4 | 500 | 260 | 167 | 1,151 | |
| Oil 2 | bbl/day | | | | | | |
| Upgraded Heavy | 853,500 lb/hr | 8,751 | 792.5° F. | 422.5 | 160 | 1,103 | |
| Oil 3 | | | | | | | |
| Cooled Upgraded | 853,500 lb/hr | 8,751 | 120 | 48.9 | 112.5 | 776 | |
| Heavy Oil 4 | | | | | | | |
| Liquid Product | 626,400 lb/hr | 4,356 | 119.7 | 48.7 | 14.8 | 102 | |
| 66 | | | | | | | |
| Sour Crude 65 | 484,500 lb/hr | 818.1 | 119.7 | 48.7 | 14.8 | 102 | |
| Natural Gas 5 | 910 kscf/day | 45.4 | 69.2 | 20.7 | 15.8 | 109 | |
| Input to Stripping | | | | | | | |
| Tower 58 | | | | | | | |
| Gas 67 | 233,400 lb/hr | 4,490 | 110 | 43.3 | 45 | 310 | |
| Wastewater 22 | 9,538 | 3,499 | 119.7 | 48.7 | 14.8 | 102 | |
| | bbl/day | | | | | | |
| Exhaust Gas | 520.0 | 25,900 | 507 | 263.9 | 14.8 | 102 | |
| from Furnace 17 | mscf/day | | | | | | |
| Product Crude 21 | 40,170 | 806.4 | 119.5 | 48.6 | 15.8 | 109 | API = |
| | bbl/day | | | | | | 41.2 |

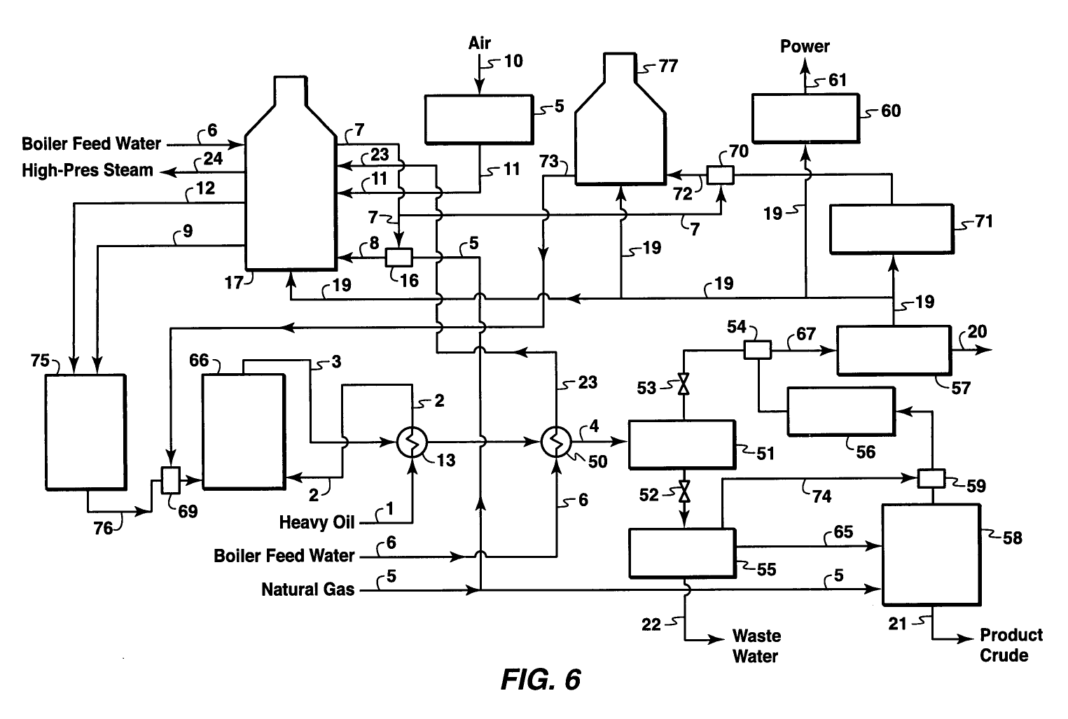

The embodiment depicted in FIG. 6 is similar to the embodiment of FIG. 5, except that a portion of fuel gas 19 is recycled to upgrade reactor 14. Since fuel gas 19 contains reactive gases, hydrogen, and carbon monoxide, this embodiment has a reduced demand for natural gas 5 within fuel mixture 9. After fuel gas 19 is compressed in compressor 71, steam is mixed in mixer 70 with fuel gas 19 to mitigate metal dusting corrosion in furnace 77. Mixture 72 is heated in furnace 77 to a temperature preferably in the range 1000 to 1500° F. (538 to 816° C.), and more preferably in the range of 1200 to 1400° F. (649 to 760° C.), and mixed with syngas in mixer 69. In this embodiment, any amount, but preferably from 0 to 70%, of fuel gas 19 can be recycled to mixer 70. Simulations again assumed 40% of heated heavy oil 2 reacts with syngas and the remaining 60% is the quenching material.

Table 4 shows that the usage of natural gas 5 is reduced by 45% due to the simulation's recycling of 50% of the fuel gas 19. This in turn reduces heated compressed air 12 and steam 7 volume requirements. Those reductions in turn lead to the benefits of reducing exhaust gas emissions from furnace 17 and of lowering the wastewater 22 volume. Product crude 21 contains 61.9 mole-percent of cracked heavy oil components. An alternative process scheme based on this embodiment would allow the recycled fuel gas to bypass the gas-treating unit. This alternative would have the advantage of a smaller gas-treating unit and would allow reactive hydrogen sulfide and hydrogen radicals in the untreated fuel gas to aid the upgrade reactions.

TABLE 4
Simulation Results for POX Reactor and Recycled Gas PCU Process
Embodiment of FIG. 6

| | | | | | | | Oil |
|---|---|---|---|---|---|---|---|
| Process | Flow | Flow Volume | Temperature | Temperature | Pressure | Pressure | Quality |
| Reference | Volume | Kg mole/hr | ° F. | ° C. | psia | kpa | API |
| Heavy Oil 1 | 40,000 | 528.4 | 199.5 | 93.1 | 169 | 1,165 | 32.8 |
| | bbl/day | | | | | | |
| Natural Gas 5 | 10.5 | 521.6 | 80 | 26.7 | 178.5 | 1,231 | |
| Input to Mixer 16 | mscf/day | | | | | | |
| Steam 7 | 78,730 lb/hr | 1,982 | 372.8 | 189.3 | 178.5 | 1,231 | |
| Heated Boiler | 579,000 lb/hr | 14,580 | 596.3 | 313.5 | 1520 | 10,480 | |
| Feed Water 23 | | | | | | | |
| Heated | 80,630 lb/hr | 1,270 | 800 | 426.7 | 177 | 1,220 | |
| Compressed Air | | | | | | | |
| 12 | | | | | | | |
| Heated Fuel | 98,300 lb/hr | 2,504 | 800 | 426.7 | 177 | 1,220 | |
| Mixture 9 | | | | | | | |
| Syngas 76 | 178,900 lb/hr | 4,299 | 1401 | 760.8 | 167 | 1,151 | |
| Recycled Tail | 174,300 lb/hr | 3,383 | 1401 | 760.8 | 167 | 1,151 | |
| Gas | | | | | | | |
| Heated Heavy | 40,000 | 528.4 | 500 | 260 | 167 | 1,151 | |
| Oil 2 | bbl/day | | | | | | |
| Upgraded Heavy | 864,400 lb/hr | 8,209 | 797.6 | 425.3 | 160 | 1,103 | |
| Oil 3 | | | | | | | |
| Cooled Upgraded | 864,400 lb/hr | 8,209 | 120 | 48.9 | 112.5 | 776 | |
| Heavy Oil 4 | | | | | | | |
| Liquid Product | 617,100 lb/hr | 3,990 | 119.1 | 48.4 | 14.8 | 102 | |
| 66 | | | | | | | |
| Sour Crude 65 | 490,100 lb/hr | 849.8 | 119.1 | 48.4 | 14.8 | 102 | |
| Natural Gas 5 | 910 kscf/day | 45.4 | 69 | 20.7 | 16 | 109 | |
| Input to Stripping | | | | | | | |
| Tower 58 | | | | | | | |
| Gas 67 | 255,700 lb/hr | 4,333 | 110 | 43.3 | 45 | 310 | |
| Wastewater 22 | 8,417 | 3,088 | 119.1 | 48.4 | 14.8 | 102 | |
| | bbl/day | | | | | | |
| Exhaust Gas | 297 | 14,780 | 504.5 | 262.5 | 14.8 | 102 | |
| from Furnace 17 | mscf/day | | | | | | |
| Product Crude 21 | 40,680 | 832.5 | 117.5 | 47.5 | 14.8 | 109 | 41.9 |
| | bbl/day | | | | | | |

### EXAMPLES

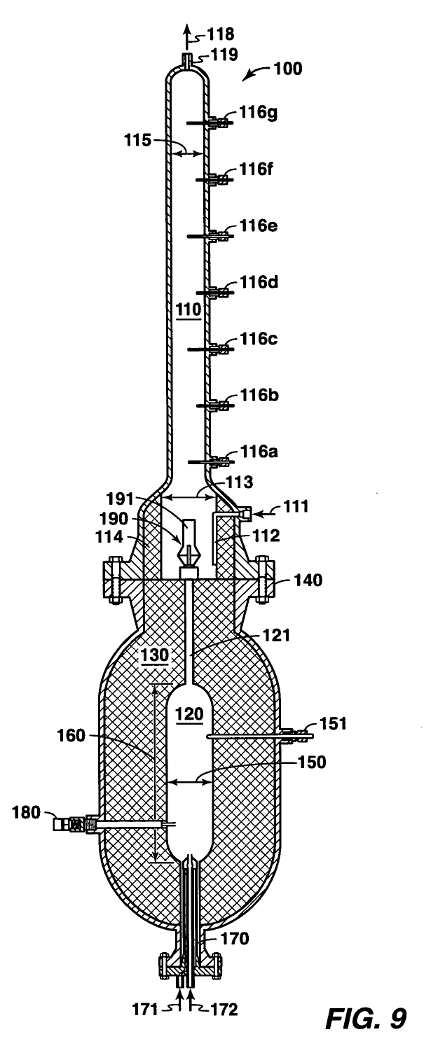

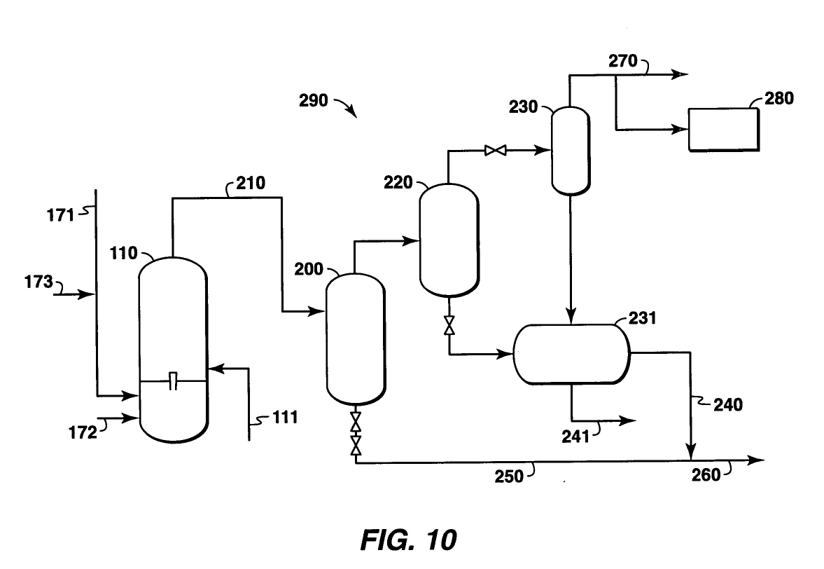

The PCU process concept with an integrated reactor system was demonstrated in a continuous flow pilot plant as depicted in FIGS. 9 and 10. As shown in FIG. 9 the integrated reactor 100 is composed of a heavy oil upgrading (PCU) reaction chamber 110 right on top of the partial oxidation (POX) reaction chamber 120, jointed by a flange connection 140. The partial oxidation reaction chamber 120 is refractory lined 130 with an internal diameter 150 of 4 inches and chamber length 160 of 16 inches. Natural gas mixed with steam 171, and air 172 are fed to the POX reaction chamber 120 through a face mixing injector 170. An electronic controlled hot-surface igniter 180 is used to initiate the thermal partial oxidation reaction. Hot syngas generated in the POX reaction chamber 120 is sent to the PCU reaction chamber 110 through a syngas passage 121 and through the orifice of the eduction nozzle 190. Heavy crude oil 111 is fed to the bottom of the PCU reaction chamber 110 through a deep tube 112. The bottom section of the PCU reaction chamber 110 has an internal diameter 113 of 4.9 inches and is refractory lined 114 to reduce heat loss. Hot syngas is injected into the mixing chamber 191 of the eduction nozzle 190 where heavy crude oil and circulated reactor fluids are first contacted and reacted. The effluent exits the nozzle chamber 191 and additional upgrading reactions occur in the PCU reaction chamber 110. Upgraded oil 118 exits the PCU reaction chamber 110 through outlet 119. The top section of the PCU reaction chamber 110 has an internal diameter 115 of 3 inches and a length of 3 feet. Multiple thermocouples 116 a-g are aligned along the top of the PCU reaction chamber 110 to measure reaction temperature. The hydrodynamics of the PCU reaction chamber 110 is strongly influenced by the eduction force of the eduction nozzle 190. In the case of a very strong eduction force, heavy oil molecules may pass through the eduction nozzle 190 multiple times before exiting the PCU reaction chamber 110.

A simplified PCU pilot plant 290 process scheme is shown in FIG. 10. Upgraded crude oil and product gas 210 exit the PCU reaction chamber 110 and enter the hot separator 200. Hydrocarbon and water vapor leaving the hot separator 200 are condensed in the cold separator 220. Additional light hydrocarbon liquid and water entrained in the product gas are collected in the knockout pot 230. Both the liquids of the cold separator 220 and knockout pot 230 are combined in an oil/water separator 231 and light oil 240 is separated out from water 241. Light oil 240 is then combined with heavy oil 250 from hot separator 200 to form the upgraded crude oil 260. Although not depicted in FIG. 10, an alternative process flow would include recycling the heavy oil 250 from the hot separator 200 back to the PCU reaction chamber 110. Product gas 270 exits the pilot plant 290 and is analyzed by an online gas chromatograph 280. Various characterizations may be carried out on the upgraded crude. Examples of two sets of reaction conditions are provided to illustrate, but are not meant to be limiting in any way, the PCU process.

### Example 1

Cold Lake bitumen was used as heavy crude oil to demonstrate the PCU process concept. Flow rates of various feed and product streams and reaction conditions are listed in Table 5.

TABLE 5

| | | Mass Flow | Temperature | Temperature | Pressure | Pressure |
|---|---|---|---|---|---|---|
| Process References | Volume Flow | gram/hr | ° F. | ° C. | psia | kpa |
| Natural Gas to POX | 32.57 scfh | 661.8 | 695.3 | 368.5 | 327.1 | 2,255.4 |
| Steam to POX | 32.72 scfh | 685.0 | 695.3 | 368.5 | 327.1 | 2,255.4 |
| Compressed Air to POX | 146.45 scfh | 5,049.9 | 711.2 | 377.4 | 335.0 | 2,309.8 |
| Syngas to PCU | 244.22 scfh | 6,396.7 | 1,619.6 | 882.0 | 316.3 | 2,180.9 |
| Heavy Crude to PCU | 1.24 b/d | 8,248.0 | 658.2 | 347.9 | 316.3 | 2,180.9 |
| PCU Chamber Bottom | | 14,644.7 | 763.3 | 406.3 | 316.3 | 2,180.9 |
| PCU Chamber Middle | | 14,644.7 | 756.5 | 402.5 | 315.8 | 2,177.4 |
| PCU Chamber Top | | 14,644.7 | 752.4 | 400.2 | 315.3 | 2,174.0 |
| C₂-C₄ in Product Gases | | 54.6 | 80.0 | 26.7 | 14.7 | 101.4 |
| C₅-C₉ in Product Gases | | 47.5 | 80.0 | 26.7 | 14.7 | 101.4 |
| Upgraded Crude | 1.22 b/d | 7,967.2 | 80.0 | 26.7 | 14.7 | 101.4 |
| Coke | | 0.0 | 80.0 | 26.7 | 14.7 | 101.4 |
| Waste Water | 0.16 b/d | 1,047.2 | 80.0 | 26.7 | 14.7 | 101.4 |

| | |
|---|---|
| Carbon Material Balance = | 97.4 Wt % |
| 1050° F. (565.6° C.) Conversion = | 39.6 Wt % |

Even under very high syngas temperature 1,619° F. (882° C.) and low hydrogen partial pressure (18% of syngas pressure) the upgrading reactions do not produce a coke product. This may be attributed to a very short reaction time inside the nozzle chamber and rapid quenching by reactor fluid after the reaction effluent exits the nozzle chamber. Embodiments of the invention produce less than 1 wt. % of coke on a fresh feed oil basis, alternatively less than 0.5 wt. % or less than 0.1 wt. % coke. The PCU reactor is very effective in minimizing secondary cracking reactions as evidenced by very low yield (<1 wt %) of light hydrocarbon gases (C₁-C₄) on a fresh feed oil basis as demonstrated above. Embodiments of the invention produce less than 4 wt. % of light hydrocarbon gases (C₁-C₄) on a fresh feed oil basis, alternatively less than 3 or 2 wt. % or less than 1 wt. % of light hydrocarbon gases (C₁-C₄). Embodiments of the invention produce over 80 wt. % of liquid products. Liquid products are materials that are liquids at room temperature and exclude gases (C₁-C₄) and coke. Embodiments of the invention produce over 85, 90 or 95 wt. % of liquid products.

Product quality data compared to raw Cold Lake bitumen are listed in Table 6. Even with 1050° F. (565.6° C.) conversion close to 40% the upgraded crude only contains a small fraction below 350° F. (177° C.). This may be due to inadequate cooling in the backend of the pilot plant which may contribute to some losses of the C₅-C₇ ligth oil fraction. Embodiments of the invention produce 1050° F. (565.6° C.) conversion on a fresh feed oil basis over 30 wt. %, alternatively over 35 wt. % or over 37.5 wt. %. The upgraded crude has much lower viscosity than raw bitumen, but it has slightly higher contents of conradson carbon and toluene insoluble. Elemental analysis indicates that the upgraded crude has higher hydrogen content than raw bitumen, while bromine number and P-value indicate that the upgraded crude is very stable.

TABLE 6

| Properties of Liquid | Unit | Cold Lake Bitumen | Upgraded Crude |
|---|---|---|---|
| <350° F. (176.7° C.) Fraction | Wt % | 0.00 | 2.59 |
| <650° F. (343.3° C.) Fraction | Wt % | 15.17 | 27.35 |
| <1050° F. (565.6° C.) Fraction | Wt % | 52.49 | 70.33 |
| >1050° F. (565.6° C.) Fraction | Wt % | 47.51 | 29.67 |
| API Gravity | | 10.07 | 11.83 |
| Kinetic Viscosity @ 40° C. | cSt | 7,730.00 | 369.00 |
| Kinetic Viscosity @ 100° C. | cSt | 128.00 | 21.62 |
| MCRT | Wt % | 13.03 | 13.78 |
| Toluene Insoluble | Wt % | 0.09 | 0.20 |
| Bromine Number | gBr₂/100 g | 17.18 | 16.52 |
| C | Wt % | 84.42 | 84.88 |
| H | Wt % | 10.03 | 10.22 |
| N | Wt % | 0.33 | 0.42 |
| S | Wt % | 4.73 | 4.26 |
| Water Content | Wt % | 0.15 | 0.26 |
| P-Value | | | 2.41 |

### Example 2

Athabasca bitumen was used as heavy crude oil for this test. The flow rates of various feed and product streams and reaction conditions are listed in Table 7.

TABLE 7

| | | Mass Flow | Temperature | Temperature | Pressure | Pressure |
|---|---|---|---|---|---|---|
| Process References | Volume Flow | gram/hr | ° F. | ° C. | psia | kpa |
| Natural Gas to POX | 30.81 scfh | 626.0 | 615.1 | 323.9 | 370.0 | 2,251.4 |
| Steam to POX | 33.99 scfh | 731.9 | 615.1 | 323.9 | 370.0 | 2,551.4 |
| Compressed Air to POX | 139.12 scfh | 4,797.4 | 629.7 | 332.1 | 378.5 | 2,609.8 |
| Syngas to PCU | 226.89 scfh | 6,155.3 | 1,530.0 | 832.2 | 368.6 | 2,541.8 |
| Heavy Crude to PCU | 0.91 b/d | 6,070.4 | 580.3 | 304.6 | 368.6 | 2,541.8 |
| PCU Chamber Bottom | | 12,225.6 | 770.5 | 410.3 | 368.6 | 2,541.8 |
| PCU Chamber Middle | | 12,225.6 | 763.0 | 406.1 | 368.1 | 2,538.3 |
| PCU Chamber Top | | 12,225.6 | 758.8 | 403.8 | 367.6 | 2,534.9 |
| C₂-C₄ in Product Gases | | 60.5 | 80.0 | 26.7 | 14.7 | 101.4 |
| C₅-C₉ in ProductGases | | 61.7 | 80.0 | 26.7 | 14.7 | 101.4 |
| Upgraded Crude | 0.89 b/d | 5,796.5 | 80.0 | 26.7 | 14.7 | 101.4 |
| Coke | | 0.0 | 80.0 | 26.7 | 14.7 | 101.4 |
| Waste Water | 0.17 b/d | 1,128.1 | 80.0 | 26.7 | 14.7 | 101.4 |

| | |
|---|---|
| Carbon Material Balance = | 97.7 wt % |
| 1050° F. (565.6° C.) Conversion = | 39.1 wt % |

The bitumen feed rate (0.91 b/d) and syngas temperature (832° C.) of example 2 are lower than example 1. Again no coke product was observed with 1050° F. (565.6° C.) conversion close to 40%. The upgraded crude oil has achieved a very high degree of viscosity reduction as shown in Table 8. Conradson carbon content of the upgraded bitumen is slightly lower than raw bitumen while the toluene insoluble maintains the same level. The upgraded crude has a slightly higher hydrogen content than raw bitumen as in Example 1. Both the bromine number and P-value show that the upgraded crude is stable without the need for further hydrotreatment.

TABLE 4

| Properties of Liquid | Unit | Athabasca Bitumen | Upgraded Crude |
|---|---|---|---|
| <350° F. (176.7° C.) Fraction | wt % | 0.00 | 2.72 |
| <650° F. (343.3° C.) Fraction | wt % | 12.25 | 26.58 |
| <1050° F. (565.6° C.) Fraction | wt % | 54.30 | 70.83 |
| >1050° F. (565.6° C.) Fraction | wt % | 45.70 | 29.17 |
| API Gravity | | 9.16 | 11.84 |
| Kinetic Viscosity @ 40° C. | cSt | 20,900.00 | 228.65 |
| Kinetic Viscosity @ 100° C. | cSt | 205.00 | 16.30 |
| MCRT | wt % | 12.93 | 12.17 |
| Toluene Insoluble | wt % | 0.03 | 0.07 |
| Bromine Number | gBr₂/100 g | 19.18 | 19.08 |
| C | wt % | 84.50 | 84.87 |
| H | wt % | 10.26 | 10.74 |
| N | wt % | 0.36 | 0.33 |
| S | wt % | 4.83 | 4.25 |
| Water Content | wt % | 0.18 | 0.14 |
| P-Value | | | 2.03 |

It should be understood that the preceding is merely a detailed description of specific embodiments of this invention. Other embodiments may be employed and numerous changes to the disclosed embodiments may be made in accordance with the disclosure herein without departing from the spirit or scope of the present invention. For example, each of the above embodiments involve the use of a single injection reactor or upgrade reactor. The PCU process is not so limited. In particular, embodiments of the PCU process in which more than one injection or upgrade reactor are deployed in a series sequence, to thereby facilitate high upgrade efficiencies. The PCU process may also be employed in embodiments in which more than one injection or upgrade reactor are deployed in parallel, so that a higher volume heavy oil upgrade throughput may be attained. Each of these embodiments is within the scope of the present invention. The preceding description, therefore, is not meant to limit the scope of the invention. Rather, the scope of the invention is to be determined only by the appended claims and their equivalents.

All documents cited herein are fully incorporated by reference for all jurisdictions in which such incorporation is permitted and to the extent they are not inconsistent with this specification. Although some dependent claims have single dependencies in accordance with U.S. practice, each of the features in any of the dependent claims can be combined with each of the features of one or more of the other dependent claims dependent upon the same independent claim or claims. Certain features of the present invention are described in terms of a set of numerical upper limits and a set of numerical lower limits. It should be appreciated that ranges formed by any combination of these limits are within the scope of the invention unless otherwise indicated.

We claim:

1. A heavy oil upgrading reactor comprising:
a) a partial oxidation reaction chamber suitable for generating syngas, said syngas containing hydrogen gas;
b) a heavy oil upgrading reaction chamber including:
i) a high temperature reaction zone suitable for thermally cracking at least a portion of said heavy oil in the presence of said syngas at a temperature in excess of 1225° F. for less than 10 seconds to form a thermally cracked oil;
ii) a rapid quench zone suitable for quenching the thermally cracked oil with a heavy oil quench within 10 seconds of the initiation of said thermal cracking of said heavy oil in said high temperature reaction zone;
iii) a stabilization zone suitable for providing a residence time for said thermally cracked oil of from 1 to 60 minutes at a reduced temperature below 850° F. to form an upgraded oil mixture; and
iv) one or more eduction nozzle(s) suitable for receiving said syngas formed in said partial oxidation reaction chamber, said syngas flowing through said eduction nozzle at a velocity sufficient to educe heavy oil from said heavy oil reaction chamber into said eduction nozzle thereby contacting said syngas with at least a portion of said heavy oil; and
c) a passage suitable for withdrawing at least a portion of said upgraded oil mixture from said heavy oil upgrading reaction chamber.

2. The reactor of claim 1, wherein said high temperature reaction zone is principally located in said eduction nozzle.

3. The reactor of claim 2, wherein said high temperature reaction zone is completely located in said eduction nozzle.

4. The reactor of claim 3, wherein said rapid quench zone is principally located in said eduction nozzle.

5. The reactor of claim 2, wherein said heavy oil upgrading reaction chamber is suitable for internally recycling a mixture of said thermally cracked oil and said heavy oil quench to said eduction nozzle thereby enabling multiple passes of recycled oil through said high temperature reaction zone of said heavy oil upgrading reaction chamber.

6. The reactor of claim 5, wherein said reactor eduction nozzle is suitable for passing greater than 10 units of oil through said nozzle for each unit of fresh heavy oil feed entering said heavy oil upgrading reaction chamber.

7. The reactor of claim 2, wherein said partial oxidation reaction chamber contains an oxidizing agent feed passage suitable for passing an oxidizing agent composed predominantly of air into said partial oxidation reaction chamber.

8. The reactor of claim 2, wherein said heavy oil upgrading reaction chamber is suitable for operating at an internal pressure of 200 to 600 psig.

9. The reactor of claim 8, wherein said heavy oil upgrading reaction chamber is suitable for operating at a hydrogen gas partial pressure of from 40 to 120 psia.

10. The reactor of claim 2, wherein said stabilization zone is suitable for providing a residence time for the thermally cracked oil of from 20 to 50 minutes.

11. The reactor of claim 2, wherein said high temperature reaction zone is suitable for thermally cracking at least a portion of said heavy oil in the presence of said syngas at a temperature in excess of 1225° F. for less than 2 seconds.

12. The reactor of claim 2, wherein said reactor contains a plurality of eduction nozzle conduits.

13. A heavy oil upgrading process, said process producing 80 wt. % or greater of liquid products, said process comprising:
a) thermally cracking a feed oil comprising heavy oil at a temperature above 1225° F. for less than 10 seconds in the presence of a hydrogen-containing gas to produce a thermally cracked oil product;
b) quenching said thermally cracked oil product within 10 seconds of the initiation of said thermal cracking of said feed oil by mixing said thermally cracked oil product with a quench oil to form a quenched oil product; and
c) stabilizing the quenched oil product at a temperature below 850° F. for from 1 to 60 minutes to form a stabilized oil product.

14. A process according to claim 13, wherein said thermally cracking step's duration is less than 2 seconds.

15. A process according to claim 14, wherein said thermally cracking step is predominantly a gas phase thermal cracking reaction.

16. A process according to claim 15, wherein said quench oil comprises heavy oil.

17. A process according to claim 16, further including providing a fresh feed stream of heavy oil to said process at a first mass flow rate.

18. A process according to claim 17, wherein the feed oil provided to said thermal cracking step (a) comprises recycled quenched oil product and/or stabilized oil product.

19. A process according to claim 18, wherein the total mass flow rate of feed oil provided to said thermal cracking step (a) is at least 10 times greater than said first mass flow rate of said fresh feed stream.

20. A process according to claim 16, wherein heavy oil is upgraded to lighter oil in both said thermal cracking step (a) and in said stabilization step (c).

21. A process according to claim 20, wherein at least 30 percent of the total upgrading of said heavy oil occurs in said stabilization step (c).

22. A process according to claim 16, wherein said process produces less than 4 weight percent of C₁ to C₄ hydrocarbons.

23. A process according to claim 22, wherein said process produces less than 1 weight percent of C₁ to C₄ hydrocarbons.

24. A process according to claim 16, wherein said quenched oil product is stabilized for from 20 to 50 minutes.

25. A process according to claim 16, wherein said hydrogen-containing gas is syngas produced primarily from air as an oxidizing agent, said syngas containing hydrogen gas.

26. A process according to claim 25, wherein said thermal cracking step (a) is conducted at a system pressure of 200 to 600 psig.

27. A process according to claim 26, wherein said thermal cracking step (a) is conducted at a hydrogen gas partial pressure of from 40 to 120 psia.

28. A process according to claim 27, wherein said syngas production further includes the use of steam and a hydrocarbon gas, said steam to hydrocarbon gas molar ratio being from 0.5:1 to 2.0:1.

29. A process according to claim 16, wherein said process produces less than 1.0 wt. % of coke on a fresh feed oil basis.

30. A process according to claim 29, wherein said process produces less than 0.5 wt. % of coke on a fresh feed oil basis.

31. A process according to claim 30, wherein said process produces less than 0.1 wt. % of coke on a fresh feed oil basis.

32. A process according to claim 16, wherein said process produces 1050° F. conversion of greater than 30 wt. %.

33. A process according to claim 32, wherein said process produces 1050° F. conversion of greater than 35 wt. %.

34. A process according to claim 16, wherein the reaction severity index (RSI_{875° F.}) of said stabilizing step is below 300 seconds.

35. A process according to claim 16, wherein the reaction severity index (RSI_{875° F.}) of said stabilizing step is below 200 seconds.

36. A process according to claim 16, wherein said process produces 90 wt. % or greater of liquid products.

37. A process according to claim 36, wherein said process produces 95 wt. % or greater of liquid products.

38. A process according to claim 16, wherein said process is a non-catalytic process.

39. A process according to claim 16, wherein said feed oil includes up to 5 wt. % of solids.

40. A process according to claim 16, further including:
d) separating from said stabilized oil product a heavy oil fraction and recycling said heavy oil fraction to said thermal cracking step (a).

41. A stabilized oil product made by the process of claim 13.
